(19) United States
(12) Patent Application Publication
(10) Pub. No.: US 2011/0285662 A1
(43) Pub. Date: Nov. 24, 2011

(54) Apparatus and method for an actuator in an electronic device

(75) Inventor: Jani C. Maenpaa, Espoo (FI)

(73) Assignee: Nokia Corporation

(21) Appl. No.: 12/930,410

(22) Filed: Jan. 5, 2011

Related U.S. Application Data
(63) Continuation-in-part of application No. 12/783,464, filed on May 19, 2010.

(51) Int. Cl. G06F 3/045

(52) U.S. Cl. 345/174

(57) ABSTRACT

In accordance with an example embodiment of the present invention, an apparatus is disclosed. The apparatus includes a base element, a key top, a single dome switch, and a capacitive sensing system. The key top is configured to pivot in relation to the base element. The key top has a center area and a peripheral area. The single dome switch is between the base element and the key top. The single dome switch is configured to provide tactile feedback in response to a depression of the key top. The capacitive sensing system is configured to sense a capacitance corresponding to a distance between a portion of the peripheral area and the base element.

### CROSS REFERENCE TO RELATED APPLICATION

This application is a continuation-in-part of U.S. application Ser. No. 12/783,464 filed May 19, 2010, which is hereby incorporated by reference in its entirety.

### TECHNICAL FIELD

The present application relates generally to an apparatus and method for an actuator in electronic device.

### BACKGROUND

An electronic device typically comprises a variety of user interface components that enable users to interact with the electronic device. User interface components in portable electronic devices need to fulfill several requirements, such as compactness, suitability for mass manufacturing, durability, and ease of use. Increase of computing power of portable devices is turning them into versatile portable computers, which can be used for multiple different purposes. Therefore versatile user interface components are needed in order to take full advantage of capabilities of mobile devices.

Navigation keys are a type of user interface component used in many mobile devices. A navigation key may be a multi-way key which is adapted for entering information that relates to directions. The user can indicate different directions, such as up, down, left, or right, by pressing different parts of a navigation key. Directional information may be linked to various user interface operations, such a scrolling, navigation, or moving a cursor.

### SUMMARY

Various aspects of examples of the invention are set out in the claims.

According to a first aspect of the present invention, an apparatus is disclosed. The apparatus includes a base element, a key top, a single dome switch, and a capacitive sensing system. The key top is configured to pivot in relation to the base element. The key top has a center area and a peripheral area. The single dome switch is between the base element and the key top. The single dome switch is configured to provide tactile feedback in response to a depression of the key top. The capacitive sensing system is configured to sense a capacitance corresponding to a distance between a portion of the peripheral area and the base element.

According to a second aspect of the present invention, a method is disclosed. A base element is provided. A key top configured to pivot in relation to the base element is provided. The key top includes a center area and a peripheral area. A single dome switch is provided between the base element and the key top. The single dome switch is configured to provide tactile feedback in response to a depression of the key top. A capacitive switch is provided between the base element and the key top. A capacitance of the capacitive switch corresponds to a depression of the peripheral area.

According to a third aspect of the present invention, According to a third aspect of the present invention, a computer program product is disclosed. The computer program product includes a computer-readable medium bearing computer program code embodied therein for use with a computer. The computer program code includes code for generating a first signal in response to an actuation of a first capacitive switch. The first capacitive switch comprises an upper electrode and a lower electrode. The upper electrode is proximate a peripheral part of a key. The lower electrode is proximate a base element of the key. The key is configured such that the peripheral part is pivotable relative to the base element. The computer program code includes code for generating a second signal in response to an actuation of a second capacitive switch. The second capacitive switch includes the upper electrode and another different lower electrode. The another different lower electrode is proximate the base element. The lower electrodes are spaced from each other. The computer program code includes code for performing an operation, with a processor, in response to the first signal. The computer program code includes code for performing another operation, with the processor, in response to the second signal.

### BRIEF DESCRIPTION OF THE DRAWINGS

For a more complete understanding of example embodiments of the present invention, reference is now made to the following descriptions taken in connection with the accompanying drawings in which:

FIG. 1 is a diagram illustrating an electronic device comprising a navigation key according to an example embodiment of the invention;

FIG. 2 is a block diagram illustrating an electronic device comprising a navigation key according to an example embodiment of the invention;

FIG. 3 is a diagram illustrating operation of an electronic device according to an example embodiment of the invention;

FIG. 4a is a diagram illustrating a neutral position of an apparatus according to an example embodiment of the invention;

FIG. 4b is an enlarged view of region A in FIG. 4a illustrating a neutral position of an apparatus according to an example embodiment of the invention;

FIG. 5a is a diagram illustrating a first pivoted position of an apparatus according to an example embodiment of the invention;

FIG. 5b is an enlarged view of region A in FIG. 5a illustrating a first pivoted position of an apparatus according to an example embodiment of the invention;

FIG. 6a is a diagram illustrating a second pivoted position of an apparatus according to an example embodiment of the invention;

FIG. 6b is an enlarged view of region A in FIG. 6a illustrating a second pivoted position of an apparatus according to an example embodiment of the invention;

FIG. 7 is a diagram illustrating an apparatus according to an example embodiment of the invention;

FIG. 8 is a flow diagram illustrating a method according to an example embodiment of the invention;

FIG. 9 is a perspective view of another example of a navigation key used in the device shown in FIG. 1;

FIG. 10 is an exploded perspective view of the navigation key shown in FIG. 9;

FIG. 11 is another exploded perspective view of the navigation key shown in FIG. 9;

FIG. 12 is an exploded front view of the navigation key shown in FIG. 9;

FIG. 13 is an exploded partial section view of the navigation key shown in FIG. 9;

FIG. 14 is a perspective partial transparent view of the navigation key shown in FIG. 9;

FIG. 15 is a perspective partial transparent section view of the navigation key shown in FIG. 9;

FIG. 16 is a perspective partial transparent exploded section view of the navigation key shown in FIG. 9;

FIG. 17 is a partial transparent top view (illustrating lower electrodes) of the navigation key shown in FIG. 9;

FIG. 18 is another partial transparent top view (illustrating upper electrode and the lower electrodes) of the navigation key shown in FIG. 9;

FIG. 19 is a section view of the navigation key (in a neutral position) shown in FIG. 9;

FIG. 20 is a section view of the navigation key (in a pivoted position) shown in FIG. 9;

FIG. 21 is a partial exploded perspective view of the navigation key with another example of lower electrodes;

FIG. 22 is a partial transparent top view of the navigation key with the another example of lower electrodes;

FIG. 23 is a partial perspective view of the navigation key and an exterior key assembly used in the device;

FIG. 24 is a partial section view of the navigation key and the exterior key assembly shown in FIG. 23;

FIG. 25 is another partial section view of the navigation key and the exterior key assembly shown in FIG. 23;

FIG. 26 is another partial section view of the navigation key and the exterior key assembly shown in FIG. 23;

FIG. 27 is a partial perspective view of another example of the navigation key and the exterior key assembly used in the device;

FIG. 28 is a partial section view of the navigation key and the exterior key assembly shown in FIG. 27;

FIG. 29 is an exploded perspective view of another example of a navigation key used in the device shown in FIG. 1;

FIG. 30 is another exploded perspective view of the navigation key shown in FIG. 29;

FIG. 31 is a perspective view of the navigation key shown in FIG. 29;

FIG. 32 is a perspective section view taken along the line 32-32 of FIG. 31;

FIG. 33 is a section view of the navigation key (in a neutral position) shown in FIG. 29;

FIG. 34 is a section view of the navigation key (in a pivoted position) shown in FIG. 29;

FIG. 35 is a partial section view of the navigation key shown in FIG. 29 with a keymat and a flexible printed wiring board;

FIG. 36 is FIG. 35 is a partial section view of the navigation key shown in FIG. 29 with a keymat and a rigid printed wiring board; and

FIG. 37 is a block diagram of an exemplary method incorporating features of the invention.

### DETAILED DESCRIPTION OF THE DRAWINGS

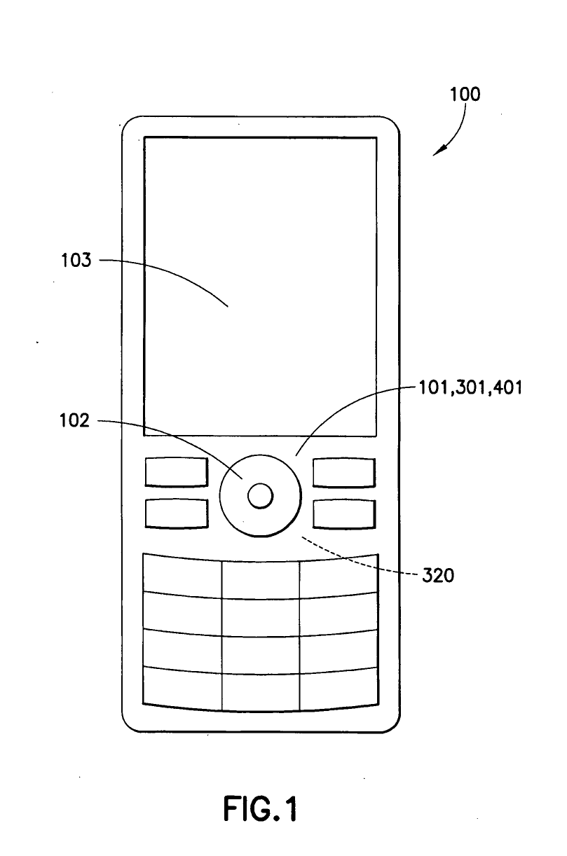

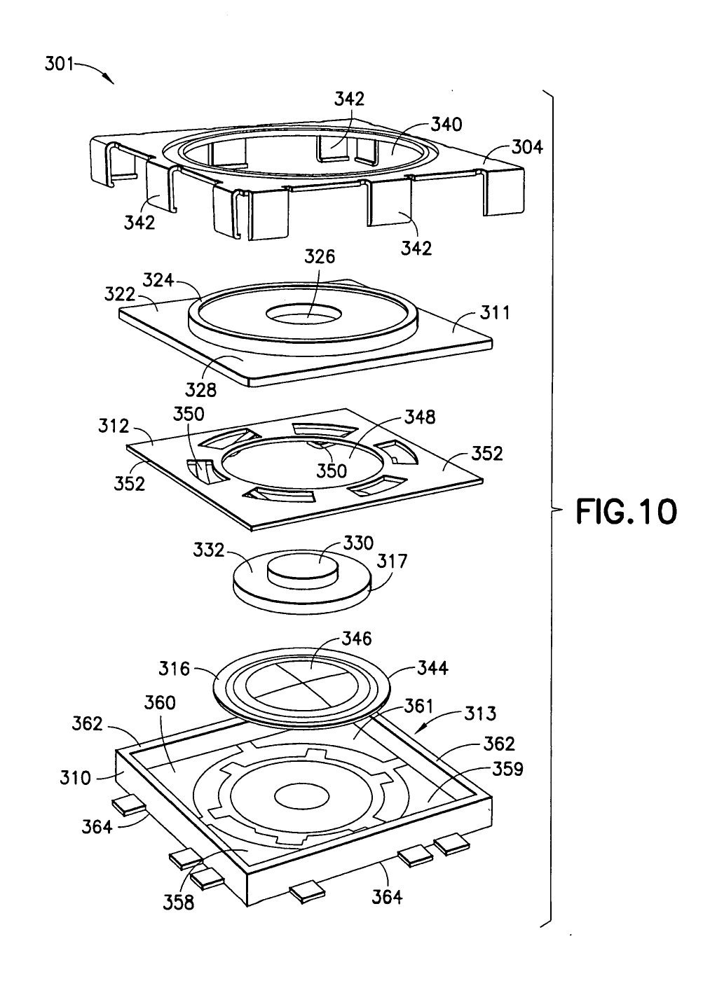

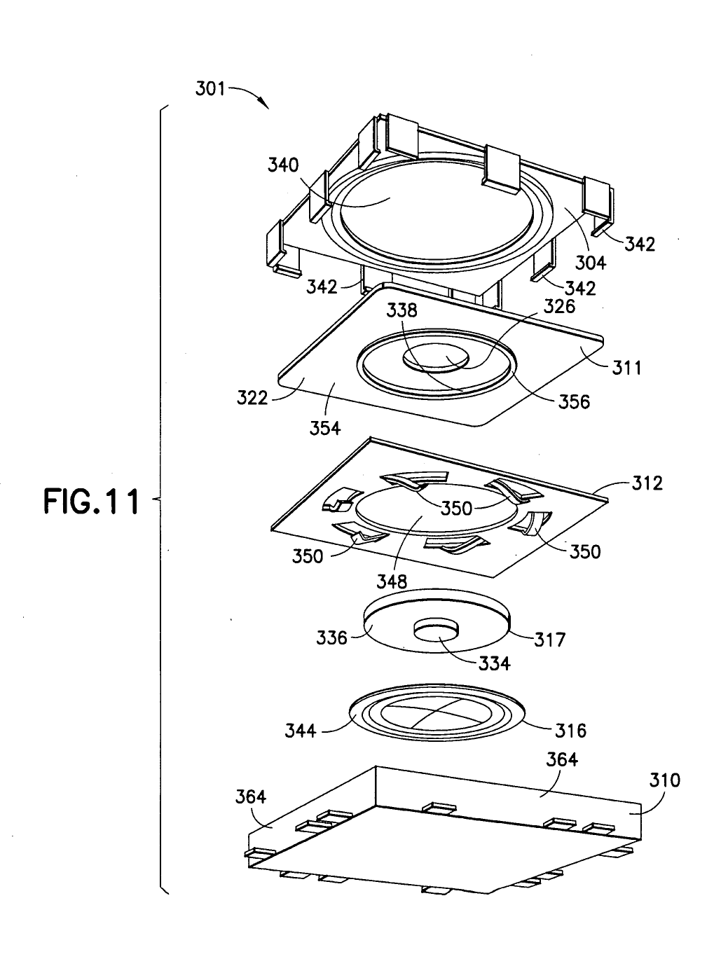

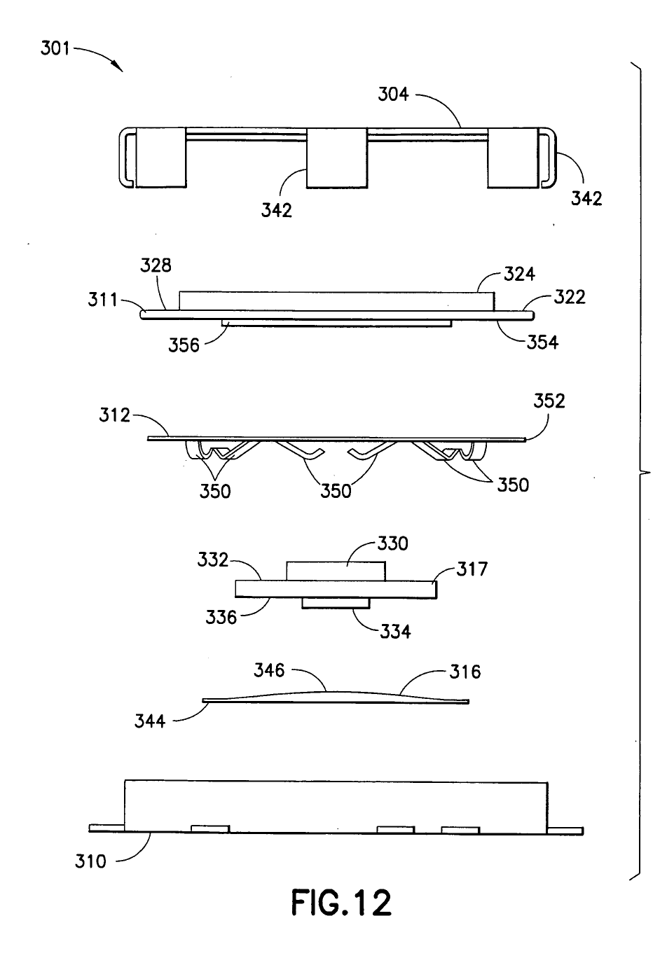

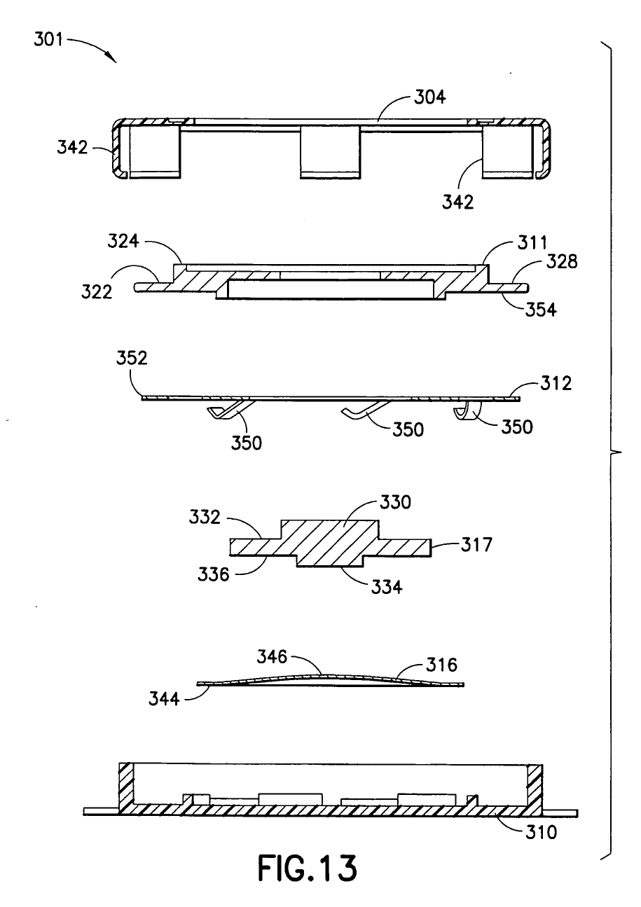

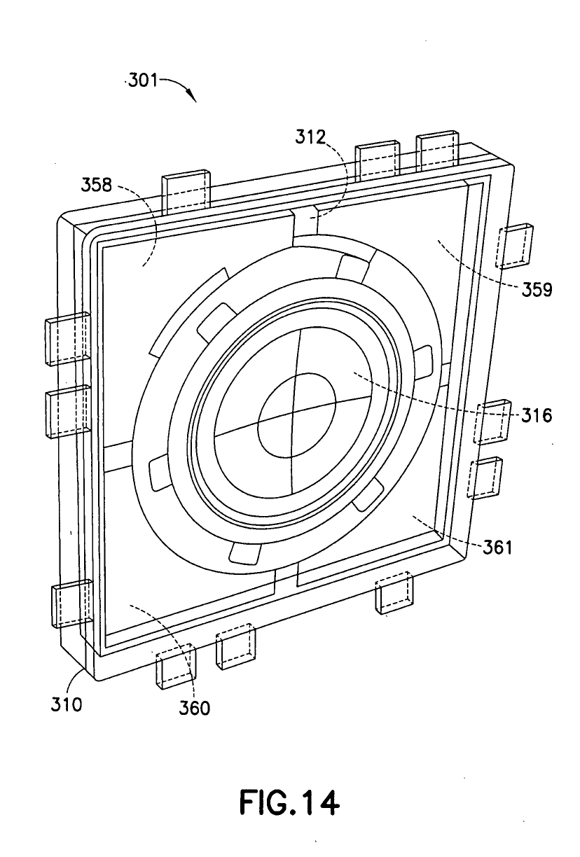

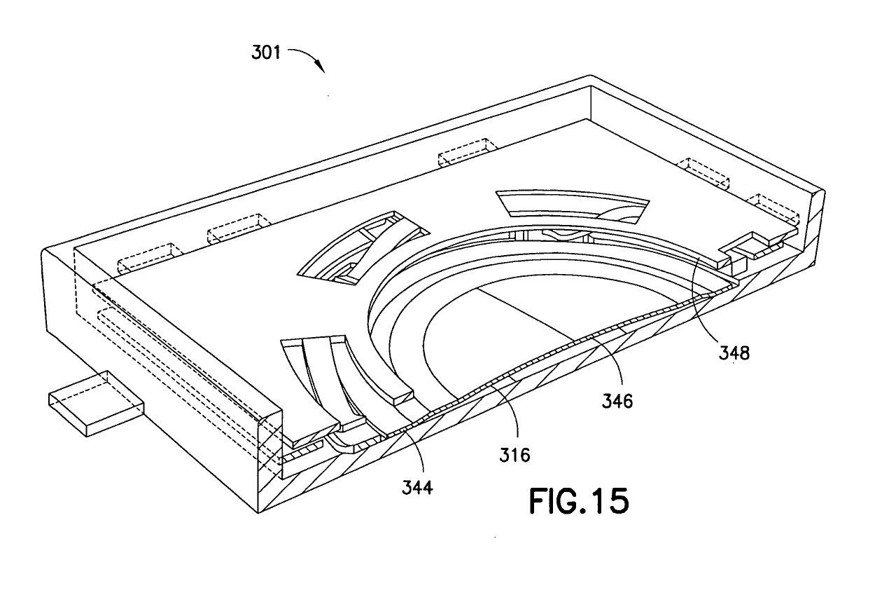

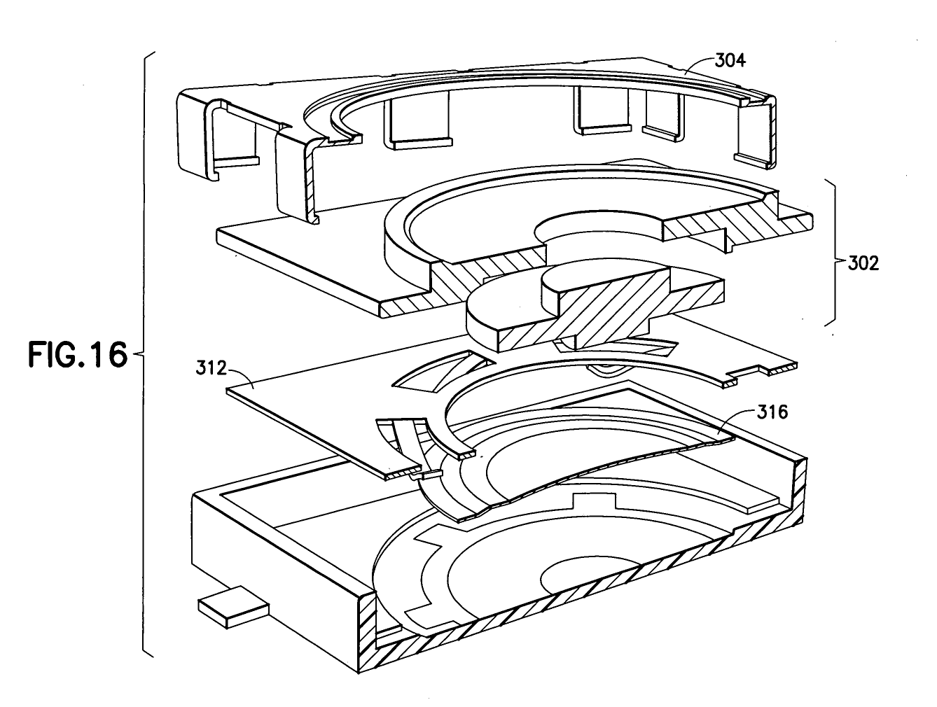

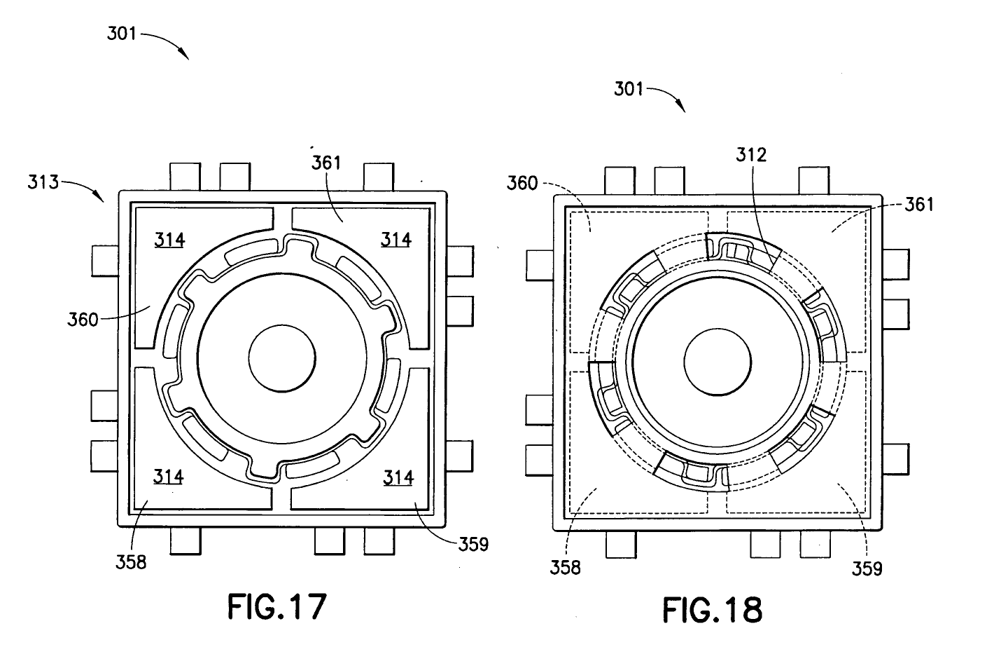

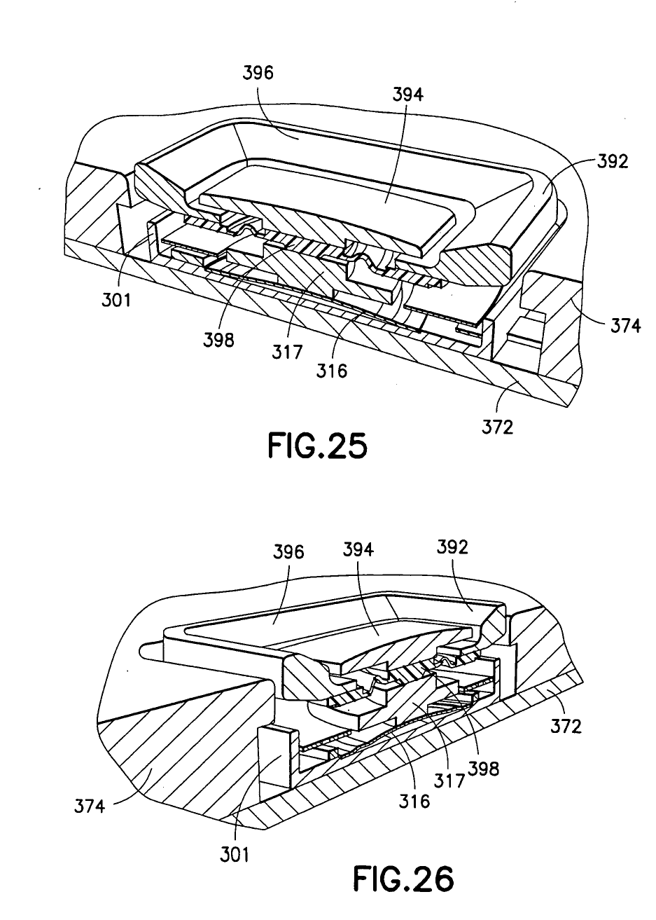

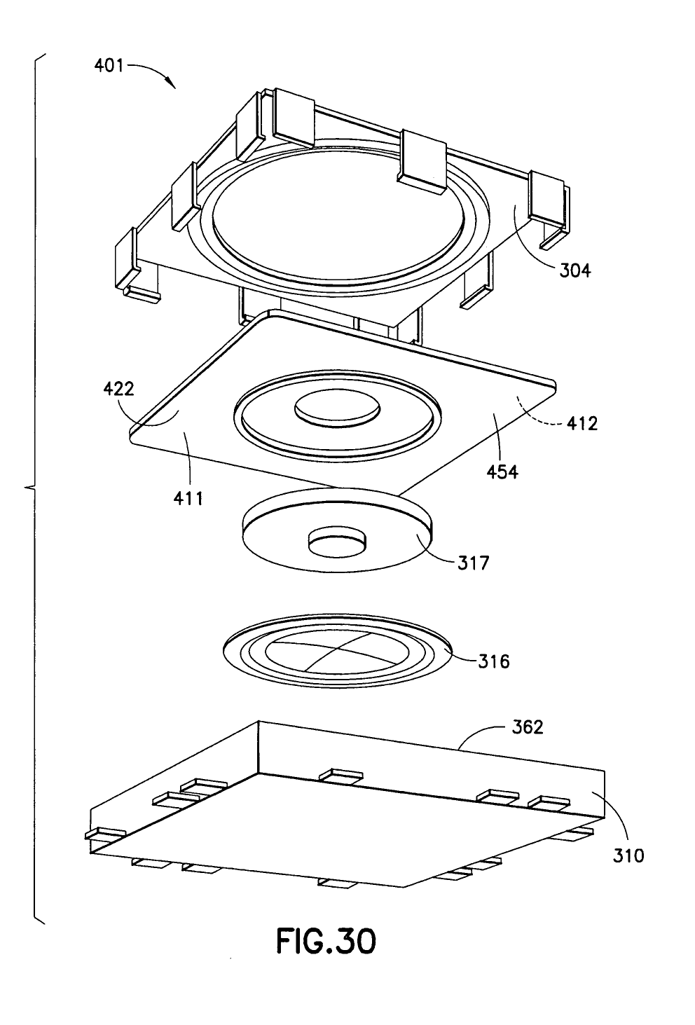

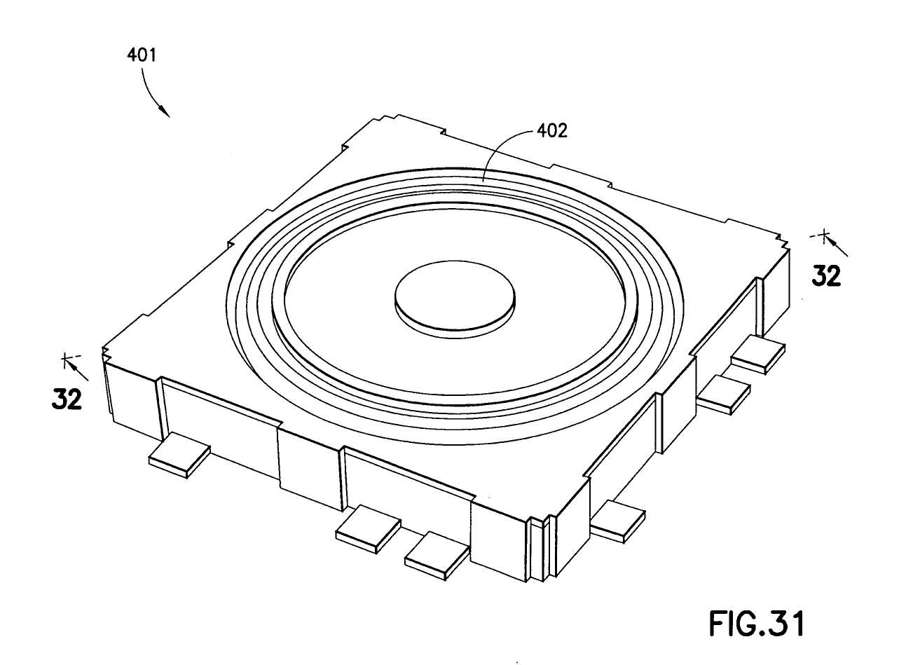

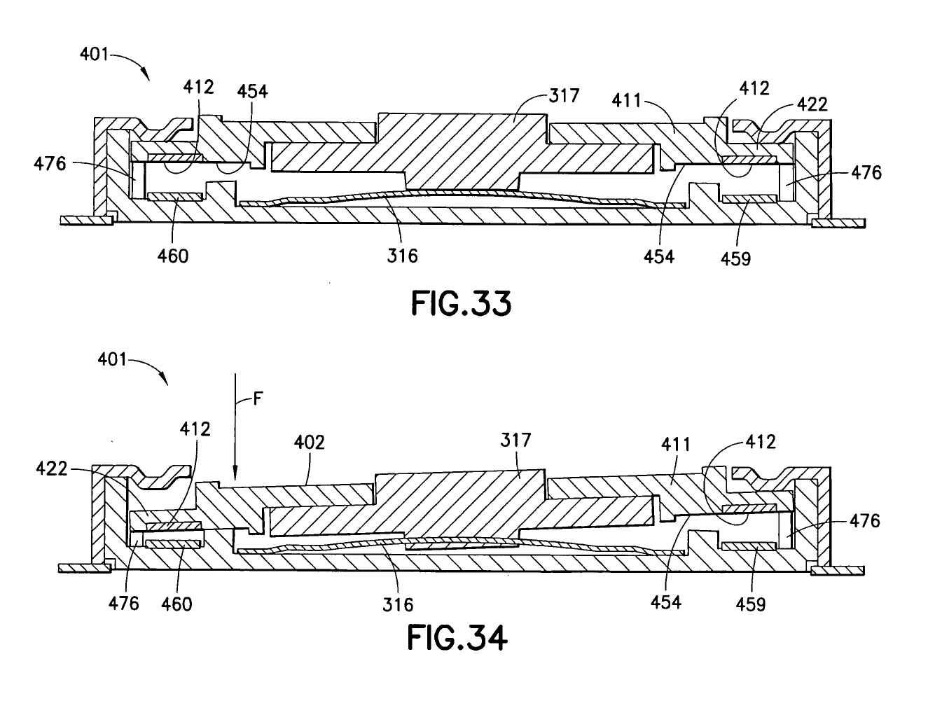

An example embodiment of the present invention and its potential advantages are understood by referring to FIGS. 1 through 37 of the drawings.

FIG. 1 is a diagram illustrating an electronic device 100 comprising a navigation key 101 according to an example embodiment of the invention. In an embodiment, the navigation key comprises a key top 102, which has an external surface accessible for the user and configured for being pressed with a finger or any other suitable object. According to FIG. 1, the electronic device 100 is illustrated as a mobile telephone. However, a navigation key 101 according to aspects of the invention may be provided in many other electronic devices without departing from the spirit of the invention. By way of example, the electronic device 100 may be an audio player, a multimedia device, a gaming device, a navigation device, a portable computer, an electronic book reader, and/or another type of electronic device. In an embodiment, the external surface of the key top 102 has a flat circular shape. In an embodiment, the key top 102 is located proximate to a display 103 of the electronic device 100. However, any suitable shape and location is possible without departing from the spirit of the invention.

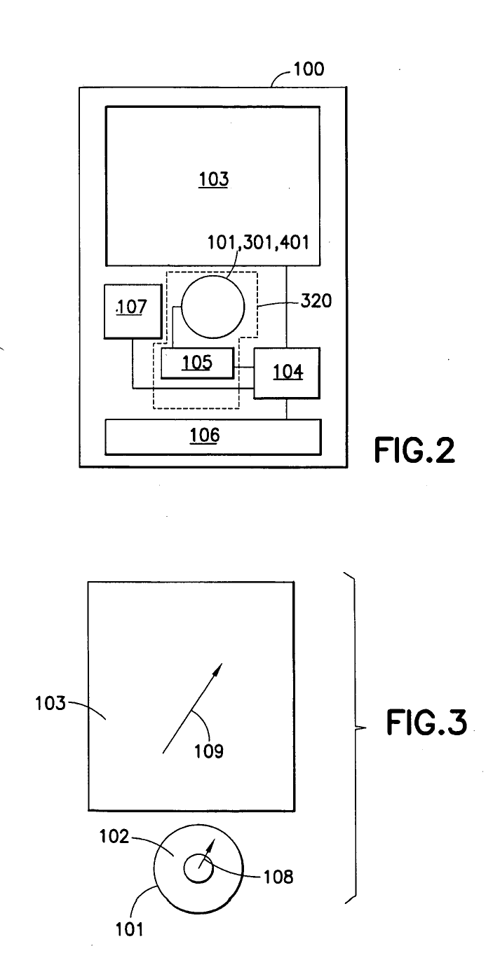

FIG. 2 is a block diagram illustrating an electronic device 100 comprising a navigation key 101 according to an example embodiment of the invention. In an embodiment, the electronic device 100 comprises a display 103 and a processor 104. In an embodiment, the navigation key 101 is a capacitive key, and the electronic device 100 comprises a capacitance sensing element 105 configured to measure a capacitance from the navigation key 101. In an embodiment, the electronic device comprises a power source 106, a memory 107, and/or other elements and components.

FIG. 3 is a diagram illustrating operation of an apparatus according to an example embodiment of the invention. FIG. 3 illustrates a key top 102 of a navigation key 101 and a display 103. In an embodiment, the electronic device 100 of FIG. 1 comprises the display 103 and the navigation key 101. In an embodiment, the navigation key 101 is configured for recognizing a direction indicated by a user. The user may indicate a direction by pressing a location on the key top with a finger or a suitable object. The location is indicated in FIG. 3 with a position vector 108, which is a vector indicating the location in relation to the center point of the key top 102. The direction of the position vector 108 may be interpreted as the direction indicated by the user. In an embodiment, a continuum of directions in a two-dimensional space is recognized. In an embodiment, a continuum of directions is a finely divided set of a plurality of discrete directions. In an embodiment, any direction within the plane of the electronic device 100 is recognized.

In an embodiment, the navigation key 101 is configured for recognizing different magnitudes of force acting on the key top 102. In an embodiment, the navigation key 101 is a capacitive key, and its capacitance is configured to vary in response to a force acting on the key top 102. In an embodiment, if the capacitance of the navigation key 101 is a first capacitance, lower than a predetermined threshold capacitance, the force acting on the key top 102 is interpreted as low. In an embodiment, if the capacitance of the navigation key 101 is a second capacitance, higher than a predetermined threshold capacitance, the force is interpreted as high. However, more than two levels of force may be recognized without departing from the spirit of the invention.

The electronic device 100 of FIG. 1 may be configured to perform an operation in response to actuation of the navigation key 101. In an embodiment, the electronic device is configured to perform a first function in response to detecting the first capacitance. In an embodiment, the electronic device is configured to perform a second function in response to detecting the second capacitance. In an embodiment, the function is movement of a cursor in the direction indicated by the user. The movement is illustrated with a vector 109 in FIG. 3. In an embodiment, the operation may be scrolling or navigation in a content item, such as a map or a photograph, according to the direction indicated by the user. Many other operations are possible without departing from the spirit of the invention. In an embodiment, the electronic device 100 of FIG. 1 is configured to carry out the operation in different ways depending on the force acting on the key top 102. In an embodiment, if the first capacitance is detected, the operation such as movement, scrolling, or navigation is carried out at a first speed. In an embodiment, if the second capacitance is detected, the operation such as movement, scrolling, or navigation is carried out at a second speed. In an embodiment, the second speed is higher than the first speed. More than two levels of speed may be recognized without departing from the spirit of the invention.

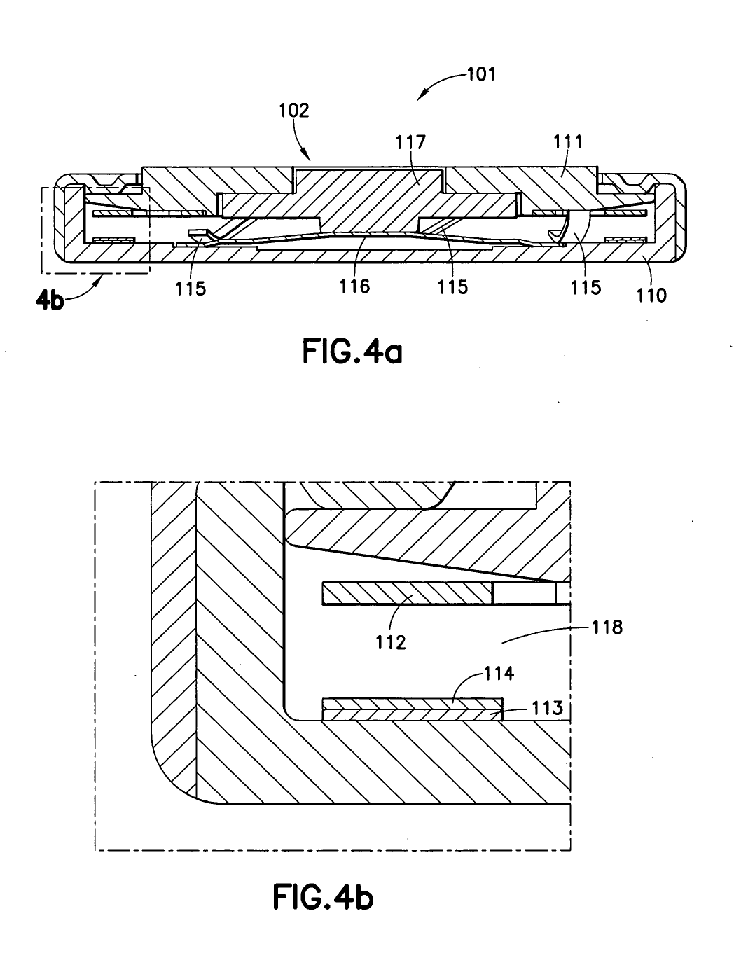

FIG. 4a is a diagram illustrating a neutral position of an apparatus according to an example embodiment of the invention. FIG. 4b is an enlarged view of region A in FIG. 4a illustrating a neutral position of an apparatus according to an example embodiment of the invention. Reference is now made to both FIGS. 4a and 4b.

FIG. 4a illustrates a navigation key 101. In an embodiment, the navigation key 101 comprises a base element 110 and a key top 102. In an embodiment, the key top 102 comprises a peripheral part 111. In an embodiment, a first electrode 112 of FIG. 4b is coupled with the key top 102. In an embodiment, the first electrode 112 of FIG. 4b is coupled with the peripheral part 111 of the key top 102. In an embodiment, a second electrode 113 of FIG. 4b is disposed on the base element 110. In an embodiment, an isolating layer 114 of FIG. 4b is disposed between the first electrode 112 of FIG. 4b and the second electrode 113 of FIG. 4b. In an embodiment, the isolating layer 114 of FIG. 4b is a layer of a suitable dielectric material configured to prevent galvanic contact between the first electrode 112 of FIG. 4b and the second electrode 113 of FIG. 4b. In an embodiment, the isolating layer 114 of FIG. 4b is disposed on the second electrode 113 of FIG. 4b. However, the isolating layer 114 of FIG. 4b may be disposed on the first electrode 112 of FIG. 4b, without departing from the spirit of the invention. Different locations and configurations of the first electrode 112 of FIG. 4b, the second electrode 113 of FIG. 4b, and the isolating layer 114 of FIG. 4b are possible without departing from the spirit of the invention. In the neutral position, an air gap 118 of FIG. 4b exists at least between the first electrode 112 of FIG. 4b and the isolating layer 114 of FIG. 4b, or the second electrode 113 of FIG. 4b and the isolating layer 114 of FIG. 4b. In an embodiment, the first electrode 112 of FIG. 4b, is not in contact with the isolating layer 114 of FIG. 4b in the neutral position. In an embodiment, the second electrode 113 of FIG. 4b, is not in contact with the isolating layer 114 of FIG. 4b in the neutral position.

The navigation key 101 further comprises one or more resilient members 115, configured to bias the key top 102 to the neutral position. In FIG. 4a, the resilient members 115 are illustrated as torsion springs. However, other types of resilient members 115 are possible without departing from the spirit of the invention. The navigation key 101 further comprises a switch element 116 disposed between the base element 110 and the key top 102. The switch element 116 is configured to be actuated when a sufficient force, having a component perpendicular to the key top 102, acts on a location proximate to the center of the key top 102. In an embodiment, the key top 102 comprises a center part 117, configured to be movable for actuating the switch element 116, without necessarily moving the peripheral part 111.

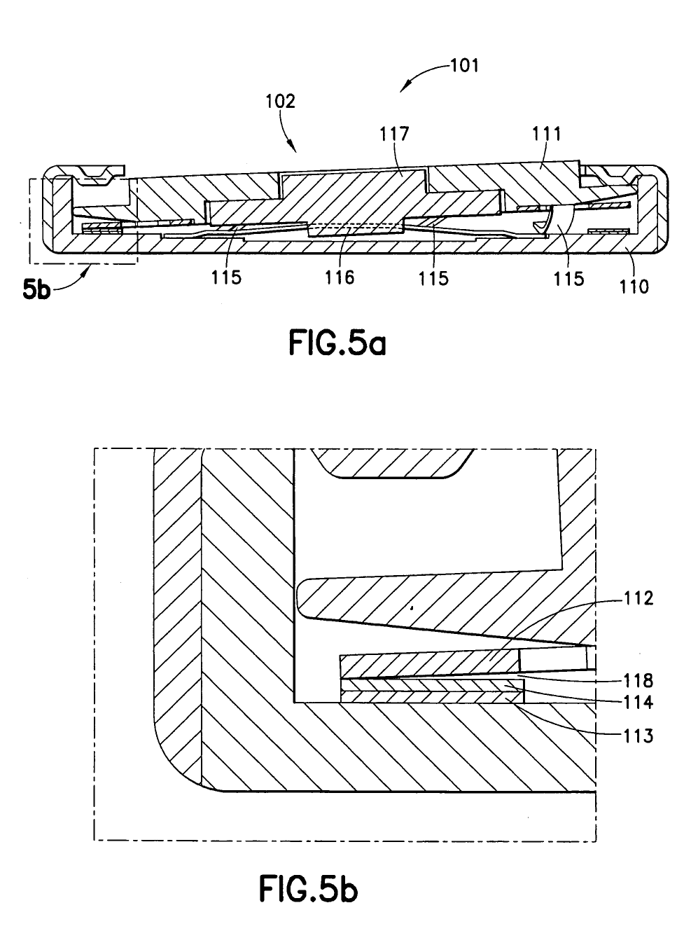

FIG. 5a is a diagram illustrating a first pivoted position of an apparatus according to an example embodiment of the invention. FIG. 5b is an enlarged view of region A in FIG. 5a illustrating a first pivoted position of an apparatus according to an example embodiment of the invention. Reference is now made to both FIGS. 5a and 5b.

FIG. 5a illustrates a navigation key 101 such as in FIGS. 4a and 4b. In the first pivoted position, the key top 102 is inclined with respect to the base element 110 in such a way that the first electrode 112 of FIG. 5b, the second electrode 113 of FIG. 5b, and the isolating layer 114 of FIG. 5b are in at least partial contact with each other and form a capacitor with a first capacitance. In an embodiment, an air gap 118 of FIG. 5b exists between a portion of the first electrode 112 of FIG. 5b and the isolating layer 114 of FIG. 5b, or a portion of the second electrode 113 of FIG. 5b and the isolating layer 114 of FIG. 5b. One of the first electrode 112 of FIG. 5b and the second electrode 113 of FIG. 5b may be configured to undergo a resilient deformation in order to take the shape of the first pivoted position.

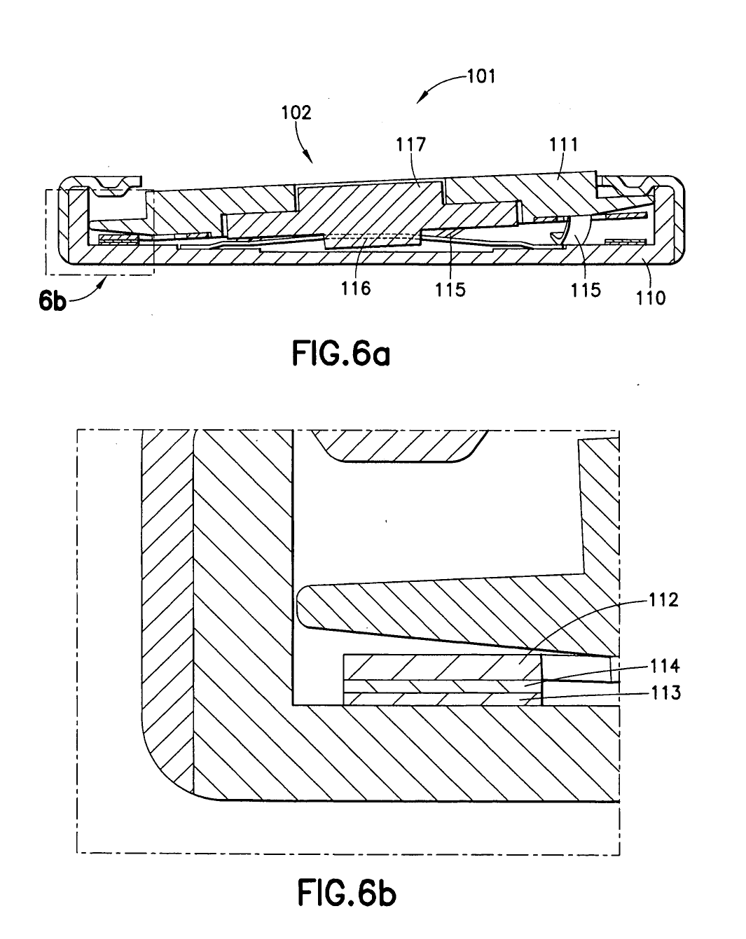

FIG. 6a is a diagram illustrating a second pivoted position of an apparatus according to an example embodiment of the invention. FIG. 6b is an enlarged view of region A in FIG. 6a illustrating a second pivoted position of an apparatus according to an example embodiment of the invention. Reference is now made to both FIGS. 6a and 6b.

FIG. 6a illustrates a navigation key 101 such as in FIG. 4a, 4b, 5a or 5b. In the second pivoted position, the key top 102 is inclined with respect to the base element 110 in such a way that the first electrode 112 of FIG. 6b, the second electrode 113 of FIG. 6b, and the isolating layer 114 of FIG. 6b are in at least partial contact with each other and form a capacitor with a second capacitance. In an embodiment, substantially no air gap exists between the first electrode 112 of FIG. 6b and the isolating layer 114 of FIG. 6b, or the second electrode 113 of FIG. 6b and the isolating layer 114 of FIG. 6b. At least one of the first electrode 112 of FIG. 6b and the second electrode 113 of FIG. 6b may be configured to undergo a resilient deformation in order to take the shape of the second pivoted position.

Reference is now made to FIGS. 5a, 5b, 6a, and 6b. In an embodiment, the navigation key 101 is configured to take the first pivoted position illustrated in FIGS. 5a and 5b as a result of a force acting on the peripheral part 111 of the key top 102, the force having a magnitude lower than a predetermined threshold magnitude. In an embodiment, the navigation key 101 is configured to take the second pivoted position illustrated in FIGS. 6a and 6b as a result of a force acting on the peripheral part 111 of the key top 102, the force having a magnitude higher than a predetermined threshold magnitude. In an embodiment, a capacitor comprising the first electrode 112, the second electrode 113 and the isolating layer 114 in the second pivoted position has a higher active surface area than in the first pivoted position. In an embodiment, an air gap between the first electrode 112 and the isolating layer 114, or the second electrode 113 and the isolating layer 114 is diminished in the second pivoted position compared with the first pivoted position. In an embodiment, the capacitor comprising the first electrode 112, the second electrode 113 and the isolating layer 114 in the first pivoted position has a first capacitance, lower than a predetermined threshold capacitance. In an embodiment, the capacitor comprising the first electrode 112, the second electrode 113 and the isolating layer 114 in the second pivoted position has a second capacitance, higher than a predetermined threshold capacitance. The predetermined threshold capacitance may correspond to the predetermined threshold magnitude of force.

Reference is now made to FIGS. 1, 2, and 3 in connection with FIGS. 5a, 5b, 6a, and 6b. Consider a force acting on the key top 102 at a location indicated by the position vector 108 in FIG. 3, the magnitude of the force being lower than a predetermined threshold magnitude. The force may result from a user pressing the key top 102 with a finger or a suitable object. As a result, the navigation key 101 may take the first pivoted position such as in FIGS. 5a and 5b, the first electrode 112, the second electrode 113 and the isolating layer 114 forming a capacitor with a first capacitance. Consider further a force acting on the key top 102 at a location indicated by the position vector 108 in FIG. 3, the magnitude of the force being higher than a predetermined threshold magnitude. The force may result from a user pressing the key top 102 with a finger or a suitable object. As a result, the navigation key 101 may take the second pivoted position such as in FIGS. 6a and 6b, the first electrode 112, the second electrode 113 and the isolating layer 114 forming a capacitor with a second capacitance. In an embodiment, the first capacitance is identified with a low force acting on the key top 102, and the second capacitance is identified with a high force acting on the key top 102. In an embodiment, the capacitance sensing element 105 of FIG. 2 is configured to sense the capacitance of the capacitor comprising the first electrode 112, the second electrode 113 and the isolating layer 114. The processor 104 of FIG. 2 may be configured to cause the electronic device 100 of FIG. 1 to perform an operation, such as movement of a cursor, or scrolling a content item such as a map or a photograph at one of two speed levels, based on the capacitance sensed by the capacitance sensing element 105 of FIG. 2. More than two levels of capacitance may be recognized without departing from the spirit of the invention.

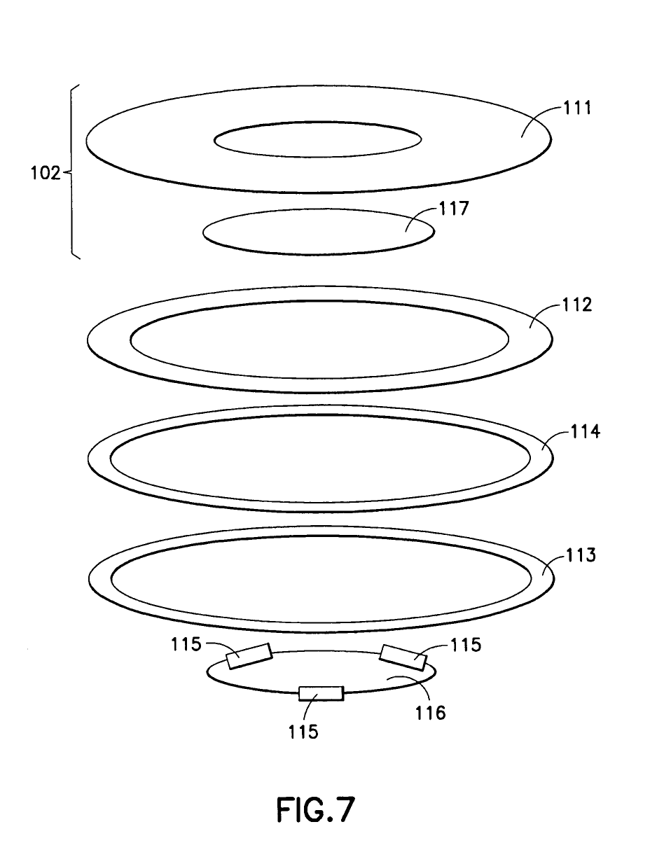

FIG. 7 is a diagram illustrating an apparatus according to an example embodiment of the invention. The diagram may be a partial exploded perspective view of the apparatus of any of FIG. 4a, 4b, 5a, 5b, 6a, or 6b. In an embodiment, the apparatus comprises a key top 102, comprising a peripheral part 111 and a center part 117. In an embodiment, the apparatus further comprises a first electrode 112, a second electrode 113, and an isolating layer 114, the isolating layer 114 being located generally between the first electrode 112 and the second electrode 113. In an embodiment, the apparatus further comprises a switch element 116, which is a dome switch or any other type of switching element. In an embodiment, the apparatus further comprises a resilient member 115, which is a torsion spring or any other type of spring or resilient element. A plurality of resilient members 115 may be provided.

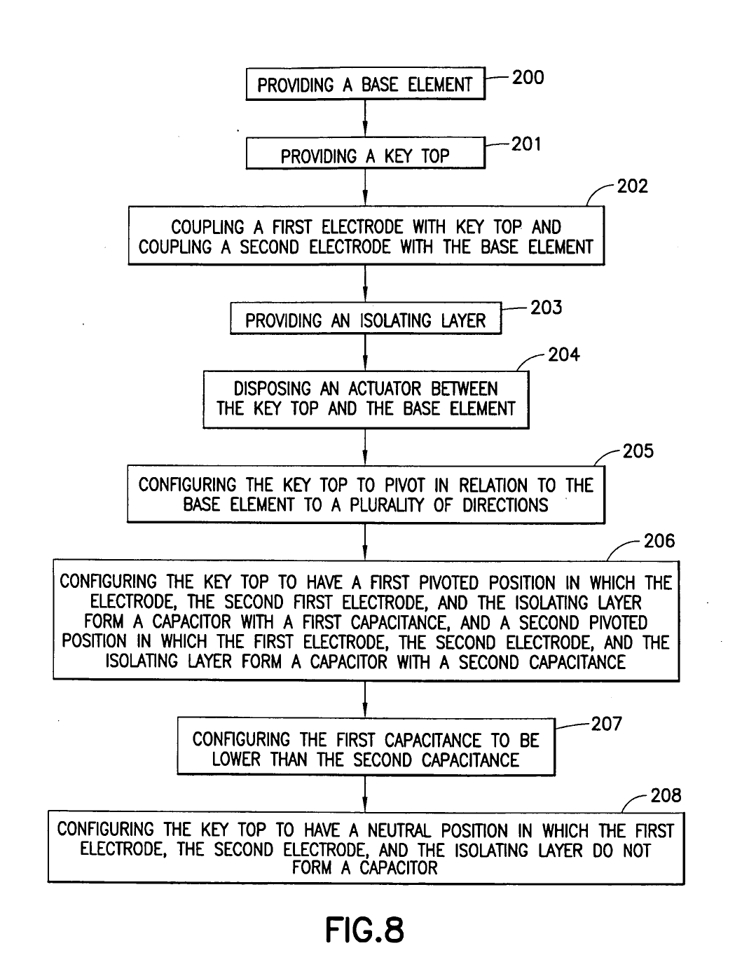

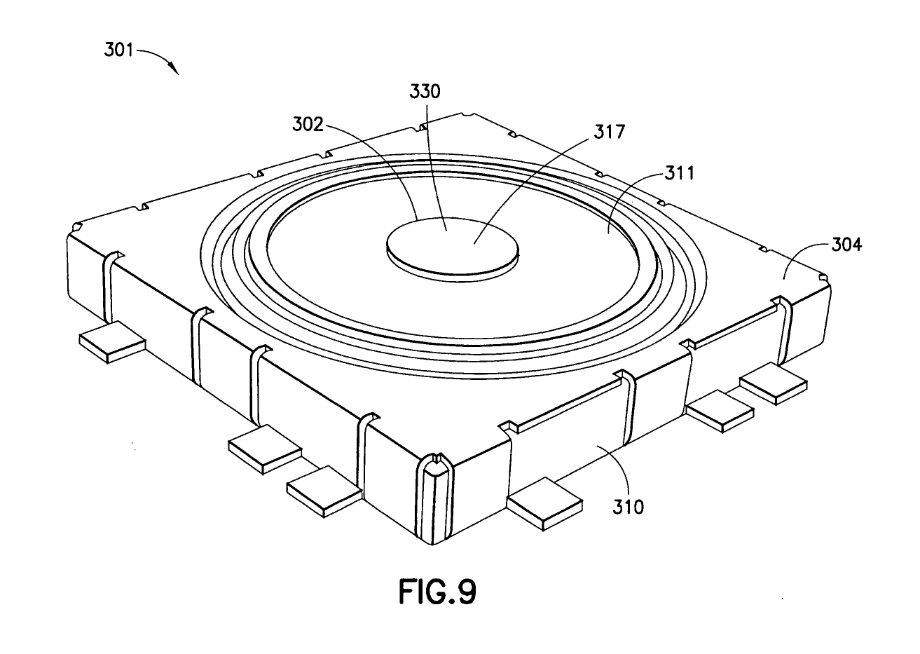

FIG. 8 is a flow chart describing a method according to an example embodiment of the invention. In an embodiment, the method is a manufacturing method for a navigation key according to embodiments of the invention. At 200, a base element 110 of FIG. 4a, 5a, or 6a is provided. At 201, a key top 102 of FIG. 4a, 5a, or 6a is provided. At 202, a first electrode 112 of FIG. 4a, 5a, or 6a is coupled with the key top 102 and a second electrode 113 of FIG. 4a, 5a, or 6a is coupled with the base element 110. At 203, an isolating layer 114 of FIG. 4a, 5a, or 6a is provided. The isolating layer may be connected to the first electrode 112 or the second electrode 113. At 204, a switch element 116 of FIG. 4a, 5a, or 6a is disposed between the base element 110 and the key top 102. At 205, the key top 102 is configured to pivot in relation to the base element 110 to a plurality of directions. At 206, the key top 102 is configured to have a first pivoted position in which the first electrode 112, the second electrode 113, and the isolating layer 114 form a capacitor with a first capacitance, and a second pivoted position in which the first electrode 112, the second electrode 113, and the isolating layer 114 form a capacitor with a second capacitance. At 207, the first capacitance is configured to be lower than the second capacitance. At 208, the key top 102 is configured to have a neutral position in which the first electrode 112, the second electrode 113, and the isolating layer 114 do not form a capacitor.

Referring now also to FIGS. 9-20, there is shown a navigation key 301 in accordance with another embodiment of the invention. The navigation key 301 is similar to the navigation key 101. The navigation key (or capacitive rocker key) 301 comprises a key top 302, a covering 304, a frame 310, an upper electrode 312, a dome switch 316, and a lower electrode group 313. Similar to the various embodiments presented above, the navigation key 301 is a capacitive key, and the capacitance sensing element 105 of electronic device 100 is configured to measure a capacitance from the navigation key 301. According to various exemplary embodiments of the invention, the navigation key 301, and the sensing element 105 form a capacitive sensing system 320 (see FIG. 2). Additionally, in some embodiments the capacitive sensing system 320 may further comprise a dedicated memory and processor. However, any suitable configuration may be provided.

According to some embodiments of the invention, the navigation key 301 comprises a surface mount device (SMD) type capacitive rocker key configured to provide tactile feedback in substantially all directions. In one embodiment, the SMD type device comprises pins for connecting the key 301 to a circuit board and/or other components. However, in alternate embodiments, any suitable type of input device may be provided. For example, according to some embodiments of the invention, the navigation key, or key element, 301 includes a capacitive switch, wherein the capacitive switch (together with the dome switch) is configured to provide a click feeling for the user pressing the key. Additionally, according to some embodiments of the invention, the capacitive switch may be used to differentiate whether the user pressed the center or one of the edges of the key top.

Similar to the key top 102, the key top 302 comprises an external surface accessible for the user and configured for being pressed with a finger or any other suitable object. The key top 302 comprises an actuator plate 311 and an actuator 317.

According to various exemplary embodiments, the actuator plate (or peripheral area/part) 311 comprises a base portion 322 having a general flat plate shape and raised portion 324 proximate a middle section of the actuator plate 311. The actuator plate 311 further comprises an opening 326 extending through the raised portion 324. The actuator plate 311 may be disposed between the covering 304 and the frame 310 such that a top side 328 of the base portion 322 contacts the covering 304. The actuator plate 311 is configured to move the upper electrode 311 toward the lower electrode group 313 when the actuator plate 311 is depressed.

According to various exemplary embodiments of the invention, the actuator (or center area) 317 comprises a general flat circular shape with a first protuberance 330 at a top side 332 of the actuator 317, and a second protuberance 334 at a bottom side 336 of the actuator 317. The actuator 317 is movably disposed at a receiving area 338 of the actuator plate 311 such that the first protuberance 330 extends, at least partially, through the opening 326 and the second protuberance 334 contacts the dome switch 316. This configuration allows for the actuator 317 to be movable independently of the actuator plate 311. The actuator 317 is configured to be movable for actuating the dome switch 316 when the actuator 317 is depressed. Additionally, the key top 302 is configured such that the actuator 317 moves when the actuator plate 311 is depressed.

The covering 304 and the frame 310 serve as a housing for the key top 302, the upper electrode 312, the dome switch 316, and the lower electrode group 313. The covering 304 comprises an opening 340. The opening 340 is suitably sized and shaped to allow the raised portion 324 of the actuator plate 311 (and the first protuberance 330 of the actuator 317) to be accessible. According to some embodiments of the invention, the covering 304 comprises snap-fit projections 342 configured to engage with the frame 310 for securing the covering 304 to the frame 310. However, in alternate embodiments, any suitable configuration for attaching the covering 304 to the frame 310 may be provided.

The dome switch 316 is disposed between the key top 302 and the frame 310. In particular, a base portion 344 of the dome switch 316 is at the frame (or base element) 310, and a dome portion 346 of the dome switch 316 is at the second protuberance 344 of the actuator (or center part) 317. The dome switch 316 is configured to be actuated when a sufficient force, having a component perpendicular to the key top 302, acts on a location proximate to the center of the key top 302 (such as at the first protuberance 330 of the actuator 317), without necessarily moving the actuator plate (or peripheral part) 311. Additionally, it should be noted that while various exemplary embodiments have been described in connection with a dome switch, one skilled in the art will appreciate that the invention is not necessarily so limited. For example, in some embodiments of the invention the apparatus comprises any suitable type of switch element.

The dome switch 316 is configured to bias the actuator 317 and the actuator plate 311 towards the covering 304. In addition, the dome switch 316 is configured to provide tactile feedback to a user of the device 100 when the actuator 317 or the actuator plate 311 is depressed. In some embodiments, the tactile feedback comprises a “click” feeling felt by the user when the key top 302 is depressed. However, in alternate embodiments, any suitable type of tactile feedback may be provided.

According to one example of the invention, the first electrode 312 comprises an opening 348 and a plurality of spring members 350. The opening 348 is suitably sized and shaped to allow accommodation for the actuator 317 to extend between the dome switch 316 and the actuator plate 311. The first electrode (or upper electrode) 311 may be formed as a one-piece member having a general flat plate shape. However, any suitable configuration may be provided, for example in some embodiments, the first electrode 311 may be provided as two or more separate members.

The spring (or resilient) members 350 may be integrally formed with the first electrode 312 and extend from the first electrode in a general cantilever fashion. The spring members 350 may extend between the first electrode 312 and the frame 310 at an angle (with respect to the first electrode 312 and the frame 310). However, it should be noted that in alternate embodiments, the spring members 350 may be separate members from the electrode 311.

According to some embodiments, the spring members 350 may be arranged in a substantial circular configuration between the opening 348 and edges 352 of the upper electrode 312. This configuration allows for ends of the spring members 350 to contact the frame 310 proximate the base portion 344 of the dome switch 316. Additionally, according to some embodiments of the invention, the ends of the spring members may be contacted to ground.

The first electrode 311 may be disposed at the bottom side 354 of the base portion 322 of the actuator plate 311 such that the opening 348 is substantially aligned with the receiving area 338 (allowing for the actuator 317 to extend therethrough). According to some examples of the invention, the first electrode 312 (or portions thereof) may be placed proximate to the perimeter of the key element. The spring members 350 provide a spring force configured to act on the first electrode 312 and the covering 304, with the actuator plate 311 therebetween. For example, the spring members 350 are configured to bias the actuator plate 311 to a neutral position (by lifting the first electrode with the spring force to the top/neutral position when the key top 302 is not pressed). Additionally, the spring members 350 are configured to allow the spring force to be overcome when the actuator plate 311 is depressed. It should further be noted that the spring members 350 comprise any suitable type of springs and/or resilient members. Additionally, it should be understood that according to some embodiments of the invention, six spring members may be provided, however in alternate embodiments, any suitable number of spring members can be provided.

According to some embodiments of the invention the first electrode 312 may be coupled to the actuator plate 311. For example, in some embodiments, the opening 348 may be suitably sized and shaped to form a press fit with a ridge portion 356 of the actuator plate 311. However, it should be noted that any suitable configuration for attaching or fastening the first electrode 312 to the actuator plate 311 may be provided. It should further be understood that in some embodiments , the first electrode may not be directly fastened to the actuator plate, and may instead be suitably disposed and held in place by the spring force of the spring elements 350 and the alignment of the opening 348 with the ridge portion 356. However, any suitable configuration for disposing the first electrode between the key top and the frame may be provided.

According to various exemplary embodiments of the invention, the lower electrode group 313 comprises four separate electrodes 358, 359, 360, 361. However, in alternate embodiments, any suitable number of lower electrodes may be provided. The lower electrodes 358, 359, 360, 361 may be arranged substantially opposite the first electrode 311 with a gap therebetween. According to some embodiments, the electrodes 358, 359, 360, 361 may be attached or fastened to the frame 310 in any suitable fashion. However, any suitable configuration may be provided.

The frame (or base element) 310 comprises a general square shape and is suitably sized to substantially surround the key top 302, the first electrode 312, the dome switch 316, and the lower electrode group 313. According to some examples of the invention, the frame 310 comprises a surrounding wall section 362 configured to have the covering 304 mounted thereon. For example, the snap-fit projections 342 may engage recess portions 364 proximate the wall section 362. However, any suitable configuration may be provided.

While various exemplary embodiments of the navigation key and navigation key components have been described/illustrated as having a general square shape, one skilled in the art will appreciate that the various embodiments are not necessarily so limited and that any suitable shape/configuration may be provided.

According to some embodiments of the invention, an isolating layer (or protective layer) 314 may be disposed between the first electrode 312 and the second electrode group 313. In some embodiments, the isolating layer 314 comprises a suitable dielectric material configured to prevent galvanic contact between the first electrode 312 and the second electrode group 313. In one embodiment of the invention, the isolating layer 314 comprises a thin film of material disposed on the second electrodes 358, 359, 360, 361. However, in some other embodiments, the isolating layer 314 may be disposed on the first electrode 312. Additionally, it should be noted that different locations and configurations of the first electrode 312, the second electrode group 313, and the isolating layer 314 are possible without departing from the spirit of the invention.

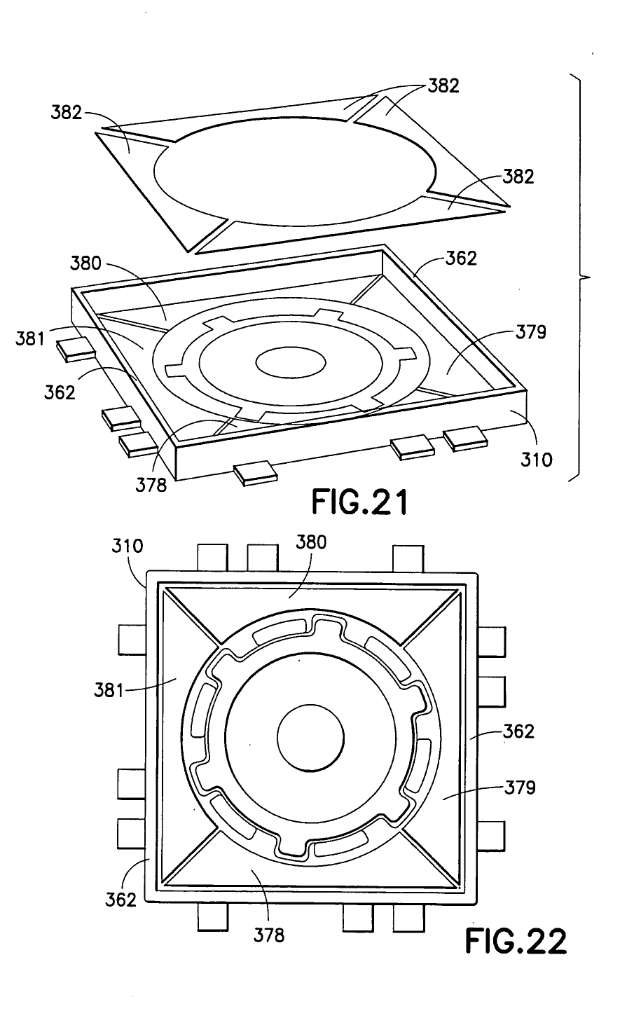

Additionally, it should be noted that although FIGS. 9-20 illustrate the lower electrodes of the lower electrode group 313 as having a general triangular shape and disposed proximate corners of the frame 310 (and extending between middle portions of the surrounding wall section 362), one skilled in the art will appreciate that various exemplary embodiments are not necessarily so limited and that other suitable electrode shapes and configurations may be provided. For example, according to some embodiments, the lower electrode group comprises electrodes 378, 379, 380, 381 which are suitably sized and shaped for extending along sides of the surrounding wall section 362 (see FIGS. 21, 22). However, any other suitable shape, configuration, or number of lower electrodes may be provided. Additionally, a protective, or insulating, film 382, similar to the insulating film 314 (see FIG. 21 illustrating a partial exploded view) comprises a shape corresponding to the lower electrodes 378, 379, 380, 381.

In an embodiment, the capacitive sensing system 320 is configured for recognizing a force acting on the key top 302 (such as a force represented by arrow 390 in FIG. 20). In an embodiment, the navigation key 301 is a capacitive key, and its capacitance is configured to vary in response to a movement of the upper electrode 312 (such as when the peripheral part/area 311 is depressed). In an embodiment, if the capacitance of the navigation key 301 changes (or varies), then the capacitive sensing system 320 recognizes that the peripheral area (or actuator plate) 311 has been depressed. In another embodiment, if the sensed capacitance of the navigation key 301 is higher than a predetermined threshold capacitance, then the capacitive sensing system 320 recognizes that the peripheral area 311 has been depressed. However, any suitable method of recognizing a depression with changing capacitance values may be provided.

The electronic device 100 may be configured to perform an operation in response to actuation of the navigation key 301. In an embodiment, the electronic device is configured to perform a function in response to detecting the variance, or change in, capacitance, when the peripheral part 311 is depressed. In an embodiment, the electronic device is configured to perform a function in response to detecting the capacitance higher than the threshold capacitance when the peripheral part 311 is depressed. According to some embodiments of the invention, this could provide for a navigation key configured to sense only one force level.

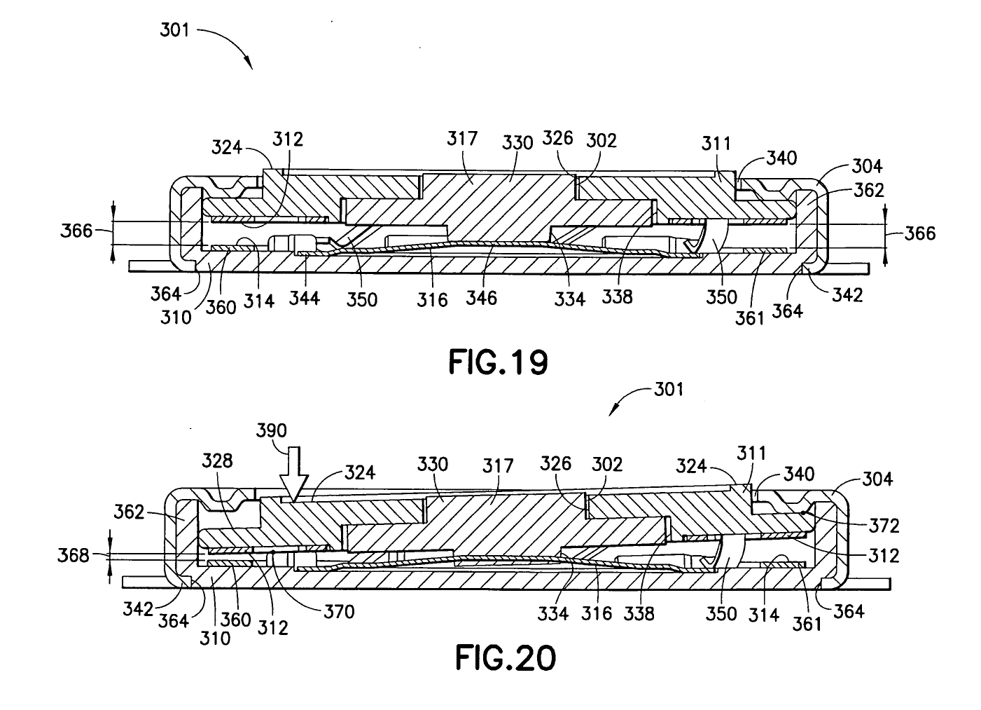

According to various exemplary embodiments of the invention, the navigation key 301 is configured to be movable between a neutral position and a pivoted position. In the neutral position (see FIG. 19), an air gap 366 exists between the first electrode 312 and the second electrode group 313 (and the isolating layer 314). In particular, in the neutral position (such as when substantially no force is applied to the key top) the air gap 366 between the first electrode and the isolating layer 314 on the lower electrodes, 358, 359, 360, 361 may be substantially the same.

In the pivoted (or tilted) position (see FIG. 20), an air gap 368 exists between the first electrode 312 and the corresponding portion of the lower electrode group 313 (and the isolating layer 314). In particular, in the pivoted position (such as when the force 390 is applied to the key top at an area of the raised portion 324 proximate the lower electrode 360) the air gap 368 between the first electrode and the isolating layer 314 on the lower electrode 360 is substantially smaller than the air gap 366. According to some embodiments of the invention, when the peripheral part 311 is depressed, the peripheral part 311 (and/or the first electrode 312) may contact a portion 370 of the frame 310, and an opposite end of the peripheral part may contact a portion 372 of the covering 304. However, in alternate embodiments, any suitable configuration may be provided.

It should further be noted that, although the FIG. 20 illustrates the air gap 368 between the lower electrode 360 and the corresponding portion of the upper electrode 312 (and the peripheral part 311) in the pivoted position, other pivoted positions may be provided. For example, if a force is applied to the key top at an area of the raised portion 324 proximate the lower electrode 358, the air gap 368 would be provided between the first electrode 312 and the isolating layer 314 on the lower electrode 358. Similarly, if a force is applied to the key top at an area of the raised portion 324 proximate the lower electrode 359, the air gap 368 would be provided between the first electrode 312 and the isolating layer 314 on the lower electrode 359. Also similar, if a force is applied to the key top at an area of the raised portion 324 proximate the lower electrode 361, the air gap 368 would be provided between the first electrode 312 and the isolating layer 314 on the lower electrode 361.

Still referring to FIG. 20, when the navigation key 301 is in the pivoted position, the first electrode 312, the second electrode 360, and the isolating layer 314 form a capacitor with a first capacitance. Similarly, capacitors may also be formed when the navigation key 301 is in the other pivoted positions. For example, the first electrode 312, the second electrode 358, and the isolating layer 314 may form a capacitor. The first electrode 312, the second electrode 359, and the isolating layer 314 may form a capacitor. The first electrode 312, the second electrode 361, and the isolating layer 314 may form a capacitor. Additionally, it should be noted that the capacitors described above are not required to be in a pivoted position. For example, according to some embodiments, the first electrode, the second electrode, and the isolating layer may form a capacitor as described above when the navigation key is in the neutral position. Furthermore, a capacitor configuration between the first electrode, the second electrode, and the isolating layer may be provided in any other suitable position of the navigation key.

Still referring to FIGS. 19 and 20, when a user presses the raised portion 324 of the peripheral area 311, this causes the upper electrode 312 to move down towards the corresponding lower electrode (of the electrode group 313) and the capacitance value changes (for example see FIG. 18 illustrating the upper electrode 312 over the lower electrodes 358, 359, 360, 361). This capacitance value can be detected by the capacitance sensing element 105. According to some embodiments of the invention, the capacitance value can be detected by a separate IC component, such as an AD7147 component. However, any suitable component may be utilized.

It should be noted that when the upper electrode 312 is moved towards the lower electrode (such as in response to a force being applied on the raised portion 324 of the actuator plate 311), various exemplary embodiments of the invention provide for preventing galvanic contact between the electrodes, as the lower electrodes comprise the insulation layer 314 on the surface between the upper electrode and the lower electrodes.

According to some embodiments of the invention, any change in the gap distance between the electrodes may change the capacitance value. In an embodiment, the capacitance sensing element 105 is configured to sense the capacitance of the capacitor (or the capacitive switch) comprising the first electrode 312, one of the lower electrodes of the lower electrode group 313, and the isolating layer 314. The processor 104 may be configured to cause the electronic device 100 to perform an operation, such as movement of a cursor, or scrolling a content item such as a map or a photograph, based on the change in capacitance sensed by the capacitance sensing element 105. However, these are merely provided as non-limiting examples and any suitable operation may be performed based on the change in capacitance.

According to some embodiments of the invention, the change in capacitance sensed by the capacitance sensing element 105 may indicate an actuation of the capacitive switch formed by the upper electrode, one of the lower electrodes, and the insulation layer. However, in alternate embodiments, the sensing element 105 may be configured to indicate an actuation of the capacitive switch when a capacitance higher than a predetermined threshold capacitance is sensed. For example, when the user presses the peripheral area substantially hard, then electrodes are almost contacted and the capacitance value may be high (and higher than the predetermined threshold capacitance). However, in other exemplary embodiments, any suitable association of the capacitance value of the capacitive switch for detecting the depression of the peripheral area 311 may be utilized.

According to some embodiments of the invention, when the actuator (or center button) 317 is pushed, then the capacitance value does not change. This is due to the configuration providing for independent movement of the actuator 317 relative to the actuator plate 311. Since the upper electrode 312 does not contact the actuator 317, any depression of only the actuator 317 results in substantially no movement of the upper electrode 312, as only the center button 317 moves. Thus, in some embodiments when the actuator (or center button) 317 is depressed, capacitance values may not be used, and instead, contact may be galvanic and made by the dome switch 316.

In addition to any galvanic contact made by the dome switch 316 when the actuator 317 is depressed, the dome switch 316 may provide a tactile feedback to the user when the actuator 317 is depressed. When the depression provides a downward force on the protuberance 330, this provides a transfer of the force to the dome portion 346 of the dome switch at the protuberance 334. According to some embodiments of the invention, the dome portion 346 may resiliently deform in response to the downward force and provide the tactile feedback, which in one embodiment comprises a “click” feeling to the user, for example. However, in alternate embodiments, any other suitable type of tactile feedback may be provided by the dome switch.

Similarly, as the actuator 317 is located at the receiving area 338 of the actuator plate 311, when the actuator plate 311 is depressed, the dome switch 316 may provide a tactile feedback to the user through the contact of the actuator 317 and the actuator plate 311. The depression on the actuator plate 311 provides a downward force on the top side 332 of the actuator 317 (at the receiving area interface), which provides a transfer of the force to the dome portion 346 of the dome switch at the protuberance 334. Similarly, the dome portion 346 may resiliently deform in response to the downward force and provide tactile feedback at the peripheral part, which comprises a “click” feeling to the user, for example. However, in alternate embodiments, any other suitable type of tactile feedback may be provided by the dome switch. Similar to the transfer of force between the actuator plate 311 and the actuator 317 when the actuator plate 311 is depressed, the tactile feedback provided by the dome switch 316 may be transferred from the dome switch 316 to the actuator 317, and from the actuator 317 to the actuator plate 311. However, in alternate embodiments, any suitable configuration may be provided.

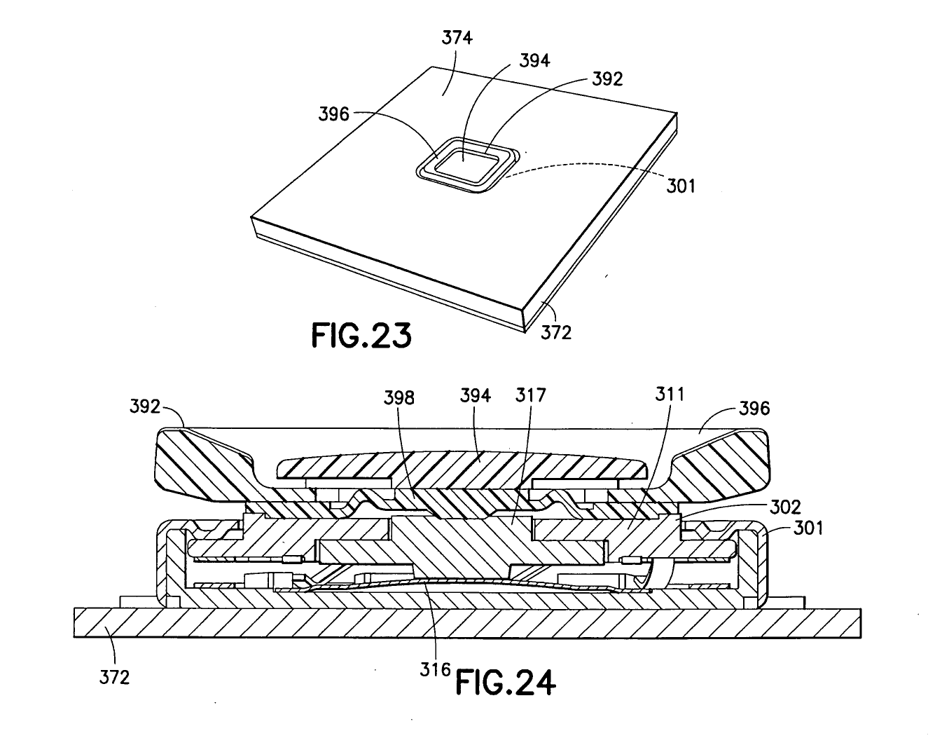

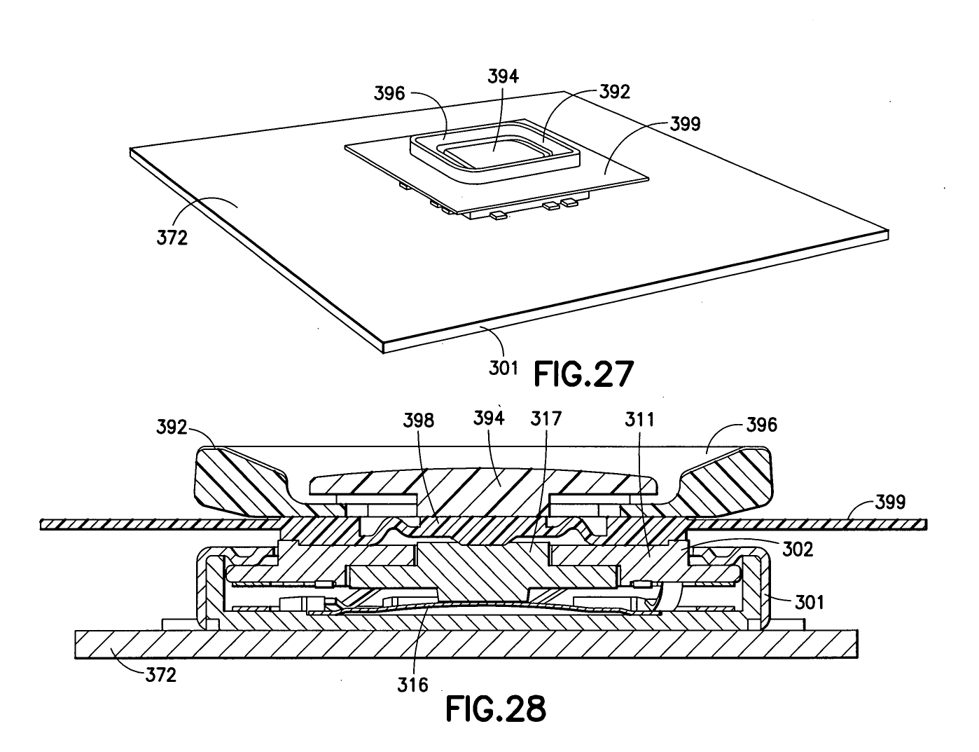

According to some embodiments of the invention, the capacitive rocker key 301 may be suitably disposed on the printed wiring board 372 for substantial alignment with an exterior key assembly 392 (see FIGS. 23-26). The exterior key assembly 392 may be accessible at a cover 374 (such as a phone/device cover, for example) of the device for user manipulation. In some embodiments, the exterior key assembly 392 comprises a middle key button 394 and an outer key element 396. The exterior key assembly 392 and the capacitive rocker key 301 may be aligned such that when the middle key button 394 is depressed, contact is made with the actuator 317 and a downward force is applied thereon. Similarly, the exterior key assembly 392 and the capacitive rocker key 301 may be aligned such that when a portion of the outer key element 396 is depressed, contact is made with the actuator plate 311 and a downward force is applied thereon. In some exemplary embodiments of the invention, a flexible member 398 may be provided between the key top 302 and the exterior key assembly 392. The flexible member 398 may be sized and shaped to correspond with the accessible portion of the key top 302, and may help improve the transfer of force between the exterior key assembly 392 and the capacitive rocker key 301 when the middle key button 394 or the outer key element 396 is depressed. Additionally, in some embodiments of the invention, the flexible member may be integrally formed with a keymat 399 of the device (see FIGS. 27-28). However, any suitable configuration may be provided. Furthermore, tactile feedback from the dome switch 316 may be provided at the exterior key assembly 392. For example, tactile feedback at the actuator 317, may be transferred to the middle key button 394 through the flexible member 398. Similarly, tactile feedback at the actuator plate 311, may be transferred to the outer key element 396 through the flexible member 398. This configuration allows for the capacitive rocker key 301 to provide tactile feedback when the exterior key assembly 392 is depressed.

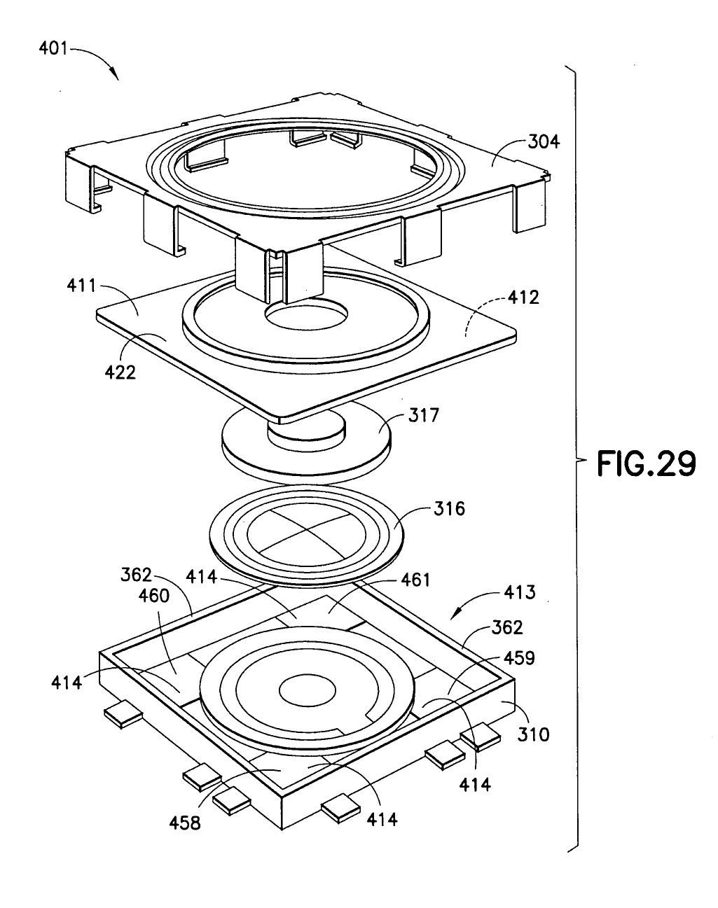

Referring now also to FIGS. 29-34, there is shown a capacitive rocker key 401 in accordance with another exemplary embodiment of the invention. The capacitive rocker key 401 comprises the covering 304, the frame 310, and the dome switch 316, similar to the embodiments described above. In this embodiment however, the first electrode (or upper electrode) 412 may be substantially flush mounted to the actuator plate (or capacitor plate) 411. In some embodiments the first electrode (or upper capacitor) 412 may be disposed to be substantially flush with the actuator plate bottom side 454. For example, in some embodiments, the first electrode 412 may be disposed within a recess portion of the actuator plate base portion 422. In some other embodiments of the invention, the first electrode 412 may be integrally formed with the actuator plate 411. However, any suitable configuration may be provided.

The navigation key 401 comprises a lower electrode group 413 including electrodes 458, 459, 460, 461. Similar to the lower electrodes 358, 359, 360, 361, the lower electrodes (or capacitors) 458, 459, 460, 461 are disposed proximate corners of the frame 310. However, in this embodiment, the electrodes 458, 459, 460, 461 comprise a smaller footprint than the electrodes 358, 359, 360, 361, and allow for a greater space between the electrodes proximate the middle portions of the surrounding wall section 362. However, any other suitable shape, configuration, or number of lower electrodes may be provided. Additionally, the protective, or insulating, film 414 comprises a shape corresponding to the lower electrodes.

Another difference between the navigation key 401 and the navigation key 301 is that the spring members 476 may be separate members from the first electrode 412. In some embodiments, the spring members 476 may be disposed on the frame 310 between the lower electrodes 458, 459, 460, 461, such as at locations proximate the middle portions of the surrounding wall section 362. In other exemplary embodiments, the spring members 476 may be provided proximate the corner sections of the frame 310. However, any suitable location or number of spring members may be provided.

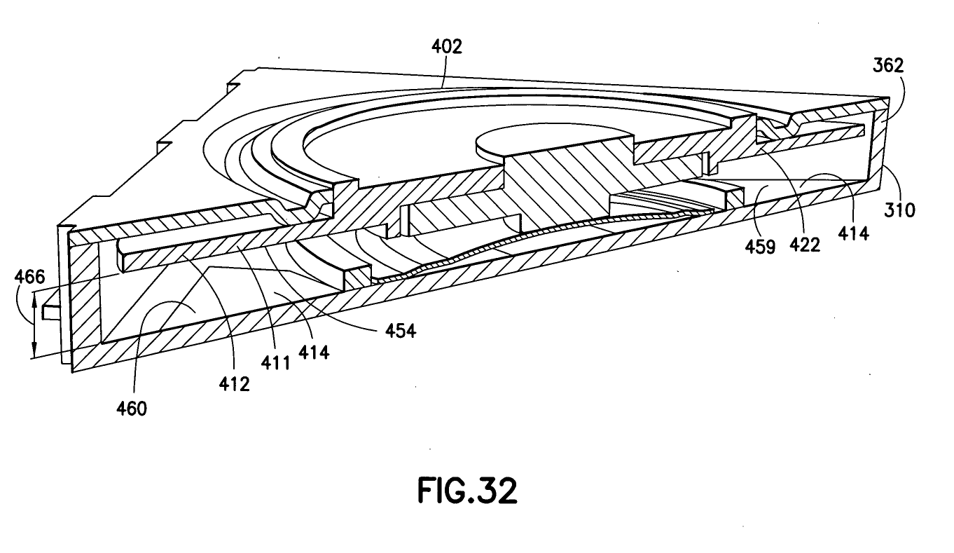

It should further be noted that similar to the various embodiments presented above, the navigation key 401 is a capacitive key, and the capacitance sensing element 105 of electronic device 100 is configured to measure a capacitance from the navigation key 401. For example, the capacitance will be changed when distance 466 (see FIG. 32) between the upper capacitor 412 and the lower capacitor changes 413 (such as when the peripheral part is depressed). Also similar to the capacitive rocker key 301, the capacitive rocker key is configured to provide tactile feedback when the key top 402 is depressed.

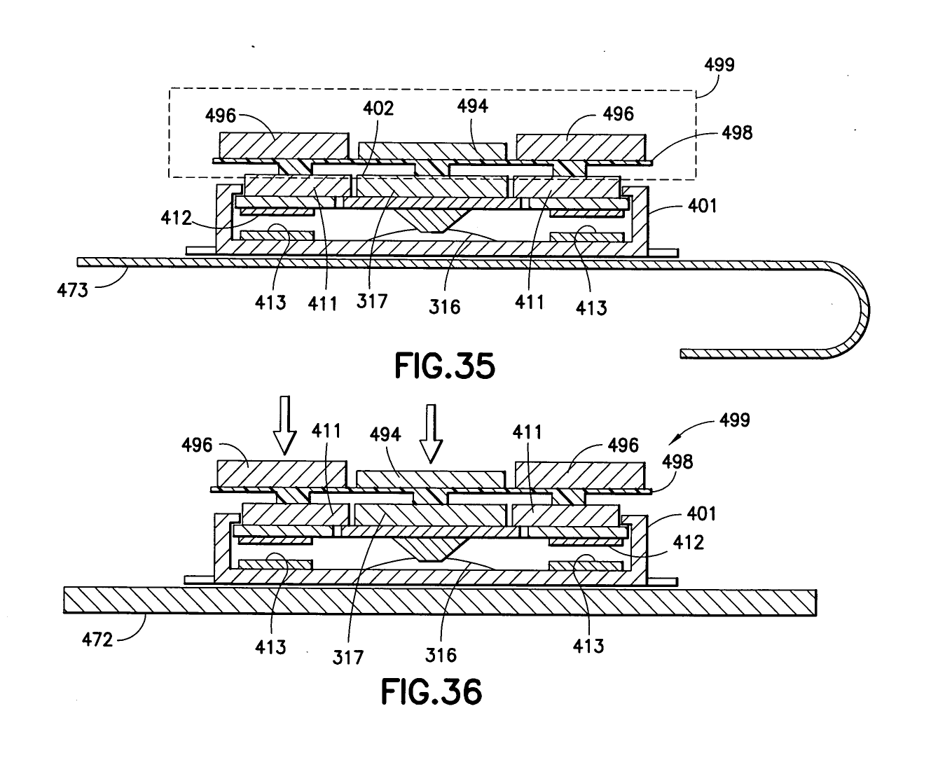

According to some embodiments of the invention, the capacitive rocker key 401 comprises a surface mounted device (SMD) type capacitive rocker key. The capacitive rocker key 401 may be suitably disposed on a flexible printed board 473 of the device and be substantially aligned with a keymat 499 of the device (see FIG. 35). In some embodiments of the invention, the keymat 499 comprises a center key 494 and a direction key 496. The keymat 499 and the capacitive rocker key 401 may be aligned such that when the center key 494 is depressed, contact is made with the actuator 317 and a downward force is applied thereon. Similarly, the keymat 499 and the capacitive rocker key 401 may be aligned such that when the direction key 496 is depressed, contact is made with the actuator plate 411 and a downward force is applied thereon. In some exemplary embodiments of the invention, a flexible member 498 may be provided between the key top 402 and the keymat 499. In some embodiments, the flexible member 498 may be a part of the keymat 499. In other embodiments, the flexible member 498 may be a separate member from the keymat 499. The flexible member 498 may be sized and shaped to correspond with the accessible portion of the key top 402, and may help improve the transfer of force between the keymat 499 and the capacitive rocker key 401 when the center key 494 or the direction key 496 is depressed. Furthermore, tactile feedback from the dome switch 316 may be provided at the keymat 499. For example, tactile feedback (or dome feedback) at the actuator 317, may be transferred to the center key 494 through the flexible member 498. Similarly, tactile feedback (or dome feedback) at the actuator plate 411 may be transferred to the direction key 496 through the flexible member 498. This configuration allows for the capacitive rocker key 401 to provide tactile feedback when the keymat 499 is depressed.

It should be noted that while, in some embodiments, the capacitive rocker key 401 has been described in connection with a flexible printed board, one skilled in the art will appreciate that exemplary embodiments of the invention are not necessarily so limited and that a rigid printed board 472 may be provided (see FIG. 36). For example, the capacitive rocker key may be suitably disposed on the rigid printed board 472 of the device and be substantially aligned with the keymat 499 as described above. However, in alternate embodiments, any suitable configuration may be provided.

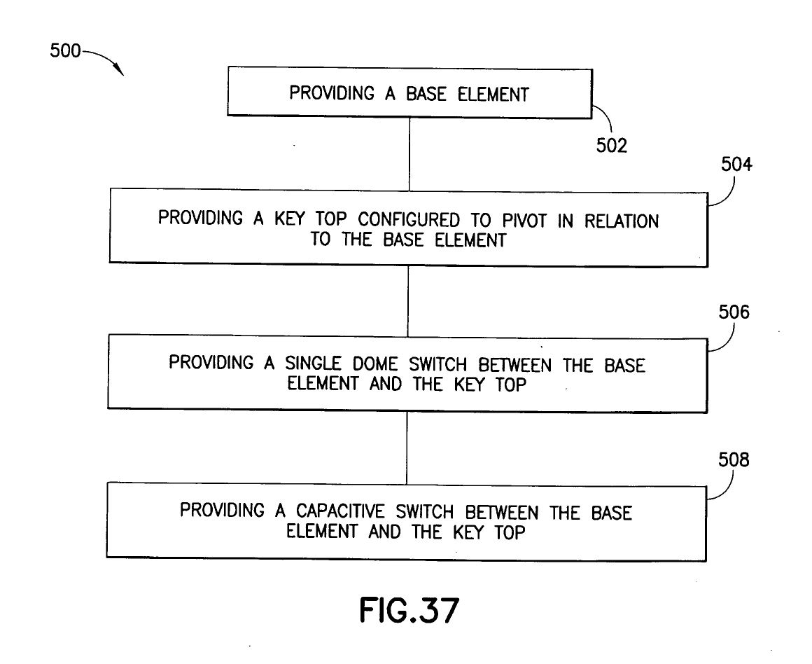

FIG. 37 illustrates a method 500. The method 500 includes providing a base element (at block 502). Providing a key top configured to pivot in relation to the base element, wherein the key top comprises a center area and a peripheral area (at block 504). Providing a single dome switch between the base element and the key top, wherein the single dome switch is configured to provide tactile feedback in response to a depression of the key top (at block 506). Providing a capacitive switch between the base element and the key top, wherein a capacitance of the capacitive switch corresponds to a depression of the peripheral area (at block 508). It should be noted that the illustration of a particular order of the blocks does not necessarily imply that there is a required or preferred order for the blocks and the order and arrangement of the blocks may be varied. Furthermore it may be possible for some blocks to be omitted.

Referring to FIG. 2, the device 100 generally comprises a controller 104 such as a microprocessor for example. The electronic circuitry includes a memory 107 coupled to the controller 104, such as on a printed circuit board for example. The memory could include multiple memories including removable memory modules for example. The device has applications, such as software, which the user can use. The applications can include, for example, a telephone application, an Internet browsing application, a game playing application, a digital camera application, a map/gps application, etc. These are only some examples and should not be considered as limiting. One or more user inputs 101, 301, 401 are coupled to the controller 104 and one or more displays 103 are coupled to the controller 104. The capacitance sensing element 105 (or the capacitance sensing system 320 including the capacitance sensing element 105) is/are also coupled to the controller 104. However, it should be noted that any suitable configuration may be provided. The device 100 may be programmed to automatically sense capacitance values, or a change in a capacitance value, when the key top is depressed.

Technical effects of any one or more of the exemplary embodiments provide a capacitive rocker key with various improvements when compared to conventional configurations. For example current mobile phones typically comprise navigation keys of a type known as “5-way navigation key”. In these known navigation keys, five separate dome switches are used to provide a click feeling for the center, and the four edges, respectively. Compared with these prior art navigation keys, various exemplary embodiments of the present invention make it possible to implement a navigation key in which only a single dome switch is needed. In addition, the navigation key can be easily configured for sensing a continuum of directions, as opposed to just, for example, four discrete directions.

Without in any way limiting the scope, interpretation, or application of the claims appearing below, a technical effect of one or more of the example embodiments disclosed herein is providing a navigation key with a single dome switch located substantially in the middle of the key plane, wherein the same dome switch provides a click feeling (or any other suitable tactile feedback) for the user regardless of whether the user presses the center of the key, or one of the edges.

It should be understood that components of the invention can be operationally coupled or connected and that any number or combination of intervening elements can exist (including no intervening elements). The connections can be direct or indirect and additionally there can merely be a functional relationship between components.

As used in this application, the term ‘circuitry’ refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

Embodiments of the present invention may be implemented in software, hardware, application logic or a combination of software, hardware and application logic. The software, application logic and/or hardware may reside on the electronic device 100 of FIG. 1. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted in FIG. 2. According to various exemplary embodiments of the invention, the computer-readable medium comprises a computer-readable storage medium that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined.

Below are provided further descriptions of various non-limiting, exemplary embodiments. The below-described exemplary embodiments are separately numbered for clarity and identification. Any of the exemplary embodiments of the invention, such as those described immediately below, may be implemented, practiced or utilized in any combination (for example, any combination that is suitable, practicable and/or feasible) and are not limited only to those combinations described herein and/or included in the appended claims.

In one exemplary embodiment, an apparatus comprising a base element, a key top, a dome switch, a capacitive switch, and a processor. The key top is configured to pivot in relation to the base element. The key top has a center area and a peripheral area. The dome switch is configured to provide a click feeling for a user pressing the key top. The capacitive switch comprises a first electrode coupled with the peripheral area and a second electrode coupled with the base element. The processor is configured to detect actuation of the capacitive switch when a user presses the peripheral area.

In one exemplary embodiment, an apparatus, comprising: a base element, a key top, a single dome switch, and a capacitive sensing system. The key top is configured to pivot in relation to the base element, the key top having a center area and a peripheral area. The single dome switch is between the base element and the key top, wherein the single dome switch is configured to provide tactile feedback in response to a depression of the key top. The capacitive sensing system is configured to sense a capacitance corresponding to a distance between a portion of the peripheral area and the base element.

An apparatus as above, wherein the single dome switch is configured to provide tactile feedback in response to a depression of the center area.

An apparatus as above, wherein the single dome switch is configured to provide tactile feedback in response to a depression of the peripheral area.

An apparatus as above, wherein the capacitive sensing system comprises a first electrode and a second electrode, wherein the first electrode is connected to the peripheral area, wherein the second electrode is connected to the base element, and wherein the capacitive sensing system is configured to sense a capacitance of the first and second electrodes in response to a depression of the peripheral area.

An apparatus as above, wherein the capacitive sensing system comprises a plurality of electrodes at the base element, and wherein the capacitive sensing system is configured to sense a capacitance of one of the plurality of electrodes in response to a depression of a corresponding portion of the peripheral area.

An apparatus as above, further comprising a protective film between the peripheral area and the base element.

An apparatus as above, wherein the capacitive sensing system comprises a capacitive switch.

An apparatus as above, wherein the single dome switch is configured to provide a click feeling to a user in response to a depression of the key top.

An apparatus as above, wherein the center area is configured to move independently of the peripheral area.

An apparatus as above, wherein the apparatus comprises a mobile phone.

In one exemplary embodiment, a method comprising: providing a base element. Providing a key top configured to pivot in relation to the base element, wherein the key top comprises a center area and a peripheral area.

Providing a single dome switch between the base element and the key top, wherein the single dome switch is configured to provide tactile feedback in response to a depression of the key top. Providing a capacitive switch between the base element and the key top, wherein a capacitance of the capacitive switch corresponds to a depression of the peripheral area.

A method as above, wherein the single dome switch is configured to provide tactile feedback in response to a depression of the center area.

A method as above, wherein the single dome switch is configured to provide tactile feedback in response to a depression of the peripheral area.

A method as above, wherein the capacitive switch comprises a first electrode and a second electrode, wherein the first electrode is coupled with the peripheral area, and wherein the second electrode is coupled with the base element.

A method as above, wherein the first electrode comprises an upper electrode, wherein the second electrode comprises a lower electrode, and wherein the method comprises providing another different lower electrode opposite the upper electrode.

A method as above, further comprising providing a protective film between the first electrode and the second electrode.

A method as above, further comprising providing a sensing element configured to detect an actuation of the capacitive switch in response to a depression of the peripheral area, wherein the capacitive switch and the sensing element form a capacitive sensing system.

In one exemplary embodiment, a computer program product comprising a computer-readable medium bearing computer program code embodied therein for use with a computer, the computer program code comprising: code for generating a first signal in response to an actuation of a first capacitive switch, wherein the first capacitive switch comprises an upper electrode and a lower electrode, wherein the upper electrode is proximate a peripheral part of a key, wherein the lower electrode is proximate a base element of the key, and wherein the key is configured such that the peripheral part is pivotable relative to the base element. Code for generating a second signal in response to an actuation of a second capacitive switch, wherein the second capacitive switch comprises the upper electrode and another different lower electrode, and wherein the another different lower electrode is proximate the base element, and wherein the lower electrodes are spaced from each other. Code for performing an operation, with a processor, in response to the first signal. Code for performing another operation, with the processor, in response to the second signal.

A computer program product as above, wherein the code for generating the first signal further comprises code for generating the first signal in response to the actuation of the first capacitive switch when a first portion of the peripheral part is depressed, and wherein the peripheral part and the base element form a rocker key with a single dome switch proximate the upper and the lower electrodes.

A computer program product as above, wherein the code for generating the second signal further comprises code for generating the second signal in response to the actuation of the second capacitive switch when a second portion of the peripheral part is depressed.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1. An apparatus, comprising:
a base element;
a key top configured to pivot in relation to the base element, the key top having a center area and a peripheral area;
a single dome switch between the base element and the key top, wherein the single dome switch is configured to provide tactile feedback in response to a depression of the key top; and
a capacitive sensing system configured to sense a capacitance corresponding to a distance between a portion of the peripheral area and the base element.

2. An apparatus as in claim 1 wherein the single dome switch is configured to provide tactile feedback in response to a depression of the center area.

3. An apparatus as in claim 1 wherein the single dome switch is configured to provide tactile feedback in response to a depression of the peripheral area.

4. An apparatus as in claim 1 wherein the capacitive sensing system comprises a first electrode and a second electrode, wherein the first electrode is connected to the peripheral area, wherein the second electrode is connected to the base element, and wherein the capacitive sensing system is configured to sense a capacitance of the first and second electrodes in response to a depression of the peripheral area.

5. An apparatus as in claim 1 wherein the capacitive sensing system comprises a plurality of electrodes at the base element, and wherein the capacitive sensing system is configured to sense a capacitance of one of the plurality of electrodes in response to a depression of a corresponding portion of the peripheral area.

6. An apparatus as in claim i further comprising a protective film between the peripheral area and the base element.

7. An apparatus as in claim 1 wherein the capacitive sensing system comprises a capacitive switch.

8. An apparatus as in claim 1 wherein the single dome switch is configured to provide a click feeling to a user in response to a depression of the key top.

9. An apparatus as in claim 1 wherein the center area is configured to move independently of the peripheral area.

10. An apparatus as in claim 1 wherein the apparatus comprises a mobile phone.

11. A method, comprising:
providing a base element;
providing a key top configured to pivot in relation to the base element, wherein the key top comprises a center area and a peripheral area;
providing a single dome switch between the base element and the key top, wherein the single dome switch is configured to provide tactile feedback in response to a depression of the key top; and
providing a capacitive switch between the base element and the key top, wherein a capacitance of the capacitive switch corresponds to a depression of the peripheral area.

12. A method as in claim 11 wherein the single dome switch is configured to provide tactile feedback in response to a depression of the center area.

13. A method as in claim 11 wherein the single dome switch is configured to provide tactile feedback in response to a depression of the peripheral area.

14. A method as in claim 11 wherein the capacitive switch comprises a first electrode and a second electrode, wherein the first electrode is coupled with the peripheral area, and wherein the second electrode is coupled with the base element.

15. A method as in claim 14 wherein the first electrode comprises an upper electrode, wherein the second electrode comprises a lower electrode, and wherein the method comprises providing another different lower electrode opposite the upper electrode.

16. A method as in claim 14 further comprising providing a protective film between the first electrode and the second electrode.

17. A method as in claim 11 further comprising providing a sensing element configured to detect an actuation of the capacitive switch in response to a depression of the peripheral area, wherein the capacitive switch and the sensing element form a capacitive sensing system.

18. A computer program product comprising a computer-readable medium bearing computer program code embodied therein for use with a computer, the computer program code comprising:
code for generating a first signal in response to an actuation of a first capacitive switch, wherein the first capacitive switch comprises an upper electrode and a lower electrode, wherein the upper electrode is proximate a peripheral part of a key, wherein the lower electrode is proximate a base element of the key, and wherein the key is configured such that the peripheral part is pivotable relative to the base element;
code for generating a second signal in response to an actuation of a second capacitive switch, wherein the second capacitive switch comprises the upper electrode and another different lower electrode, and wherein the another different lower electrode is proximate the base element, and wherein the lower electrodes are spaced from each other;
code for performing an operation, with a processor, in response to the first signal; and
code for performing another operation, with the processor, in response to the second signal.

19. A computer program product as in claim 18 wherein the code for generating the first signal further comprises code for generating the first signal in response to the actuation of the first capacitive switch when a first portion of the peripheral part is depressed, and wherein the peripheral part and the base element form a rocker key with a single dome switch proximate the upper and the lower electrodes.

20. A computer program product as in claim 19 wherein the code for generating the second signal further comprises code for generating the second signal in response to the actuation of the second capacitive switch when a second portion of the peripheral part is depressed.
